(19) United States
(12) Patent Application Publication
(10) Pub. No.: US 2023/0094192 A1
(43) Pub. Date: Mar. 30, 2023

(54) METHOD FOR IMAGE PROCESSING, METHOD FOR PROPOSAL EVALUATION, AND RELATED APPARATUSES

(71) Applicant: SHANGHAI SENSETIME INTELLIGENT TECHNOLOGY CO., LTD., Shanghai (CN)

(72) Inventors: Haisheng SU, Shanghai (CN); Mengmeng WANG, Shanghai (CN); Weihao GAN, Shanghai (CN)

(21) Appl. No.: 16/975,213

(22) PCT Filed: Oct. 16, 2019
(86) PCT No.: PCT/CN2019/111476

§ 371 Date: Aug. 24, 2020

(30) Foreign Application Priority Data
Jun. 24, 2019 (CN) 201910552360.5

(51) Int. Cl. G06T 7/13; G06T 7/174; G06T 7/11; G06T 7/00

(52) U.S. Cl. CPC G06T 7/13; G06T 7/174; G06T 7/11; G06T 7/0002; G06T 2207/10016; G06T 2207/20081; G06T 2207/20221

(57) ABSTRACT

Embodiments of the present application relate to the field of computer vision, and disclose a temporal proposal generation method and apparatus. The method includes: acquiring a first feature sequence of a video stream; obtaining a first object boundary probability sequence based on the first feature sequence, where the first object boundary probability sequence includes probabilities that the multiple segments belong to an object boundary; obtaining a second object boundary probability sequence based on a second feature sequence of the video stream, where the second feature sequence and the first feature sequence comprise same feature data arranged in a reverse order; and generating a temporal object proposal set based on the first object boundary probability sequence and the second object boundary probability sequence.

### CROSS-REFERENCE TO RELATED APPLICATION

The present application claims priority to Chinese Patent Application No. 201910552360.5, filed on Jun. 24, 2019 and entitled “METHOD FOR IMAGE PROCESSING, METHOD FOR PROPOSAL EVALUATION, AND RELATED APPARATUSES”, the disclosure of which is hereby incorporated by reference in its entirety.

### TECHNICAL FIELD

The present invention relates to the field of image processing, and in particular, to a method for image processing, a method for proposal evaluation, and related apparatuses.

### BACKGROUND

Temporal object detection technology is an important and challenging subject in the field of video behavior understanding. Temporal object detection technology plays an important role in many fields, such as video recommendation, security surveillance and intelligent home.

The temporal object detection task aims to locate the specific time of appearance of an object in a long untrimmed video and the category thereof. A major difficulty in this type of problem is how to improve the quality of the generated temporal object proposals. High-quality temporal object proposals should have two key attributes: (1) the generated proposals should cover real object labeling as much as possible; and (2) the quality of the proposals should be able to be evaluated comprehensively and accurately, and a confidence score is generated for each proposal for subsequent retrieval. At present, the used temporal proposal generation method usually has the problem that the boundary of the generated proposal is not accurate enough.

### SUMMARY

Embodiments of the present invention provide solutions for video processing.

According to a first aspect, the embodiments of the present application provide a method for image processing, including: acquiring a first feature sequence of a video stream, where the first feature sequence includes feature data of each of multiple segments in the video stream; obtaining a first object boundary probability sequence based on the first feature sequence, where the first object boundary probability sequence includes probabilities that the multiple segments belong to an object boundary; obtaining a second object boundary probability sequence based on a second feature sequence of the video stream, where the second feature sequence and the first feature sequence include the same feature data, but arranged in a reverse order; and generating a temporal object proposal set based on the first object boundary probability sequence and the second object boundary probability sequence.

In the embodiments of the present application, a temporal object proposal set is generated based on the fused object boundary probability sequences, and a probability sequence with a more precise boundary can be obtained, so that the quality of the generated temporal object proposals is higher.

In an optional implementation, before obtaining the second object boundary probability sequence based on the second feature sequence of the video stream, the method further includes: performing time sequence reversal processing on the first feature sequence to obtain the second feature sequence.

In this implementation, time sequence reversal processing is performed on the first feature sequence to obtain the second feature sequence, and the operation is simple.

In an optional implementation, generating the temporal object proposal set based on the first object boundary probability sequence and the second object boundary probability sequence includes: performing fusion processing on the first object boundary probability sequence and the second object boundary probability sequence to obtain a target boundary probability sequence; and generating the temporal object proposal set based on the target boundary probability sequence.

In this implementation, by performing fusing processing on the two object boundary sequences, an object boundary probability sequence with a more accurate boundary can be obtained, thereby generating a temporal object proposal set with higher quality.

In an optional implementation, performing fusion processing on the first object boundary probability sequence and the second object boundary probability sequence to obtain the target boundary probability sequence includes: performing time sequence reversal processing on the second object boundary probability sequence to obtain a third object boundary probability sequence; and fusing the first object boundary probability sequence and the third object boundary probability sequence to obtain the target boundary probability sequence.

In this implementation, the boundary probability of each segment in a video is evaluated in two opposite temporal directions, and a simple and effective fusion strategy is used to remove noise, so that the finally located temporal boundary has higher precision.

In an optional implementation, each of the first object boundary probability sequence and the second object boundary probability sequence includes a starting probability sequence and an ending probability sequence; performing fusion processing on the first object boundary probability sequence and the second object boundary probability sequence to obtain the target boundary probability sequence includes: performing fusing processing on the starting probability sequences in the first object boundary probability sequence and the second object boundary probability sequence to obtain a target starting probability sequence; and/or

performing fusing processing on the ending probability sequences in the first object boundary probability sequence and the second object boundary probability sequence to obtain a target ending probability sequence, where the target boundary probability sequence includes at least one of the target starting probability sequence or the target ending probability sequence.

In this implementation, the boundary probability of each segment in a video is evaluated in two opposite temporal directions, and a simple and effective fusion strategy is used to remove noise, so that the finally located temporal boundary has higher precision.

In an optional implementation, generating the temporal object proposal set based on the target boundary probability sequence includes: generating the temporal object proposal set based on the target starting probability sequence and the target ending probability sequence included in the target boundary probability sequence;

or generating the temporal object proposal set based on the target starting probability sequence included in the target boundary probability sequence and the ending probability sequence included in the first object boundary probability sequence;

or generating the temporal object proposal set based on the target starting probability sequence included in the target boundary probability sequence and the ending probability sequence included in the second object boundary probability sequence;

or generating the temporal object proposal set based on the starting probability sequence included in the first object boundary probability sequence and the target ending probability sequence included in the target boundary probability sequence;

or generating the temporal object proposal set based on the starting probability sequence included in the second object boundary probability sequence and the target ending probability sequence included in the target boundary probability sequence.

In this implementation, a candidate temporal object proposal set can be generated quickly and accurately.

In an optional implementation, generating the temporal object proposal set based on the target starting probability sequence and the target ending probability sequence included in the target boundary probability sequence includes: obtaining a first segment set based on target starting probabilities of the multiple segments included in the target starting probability sequence, and obtaining a second segment set based on target ending probabilities of the multiple segments included in the target ending probability sequence, where the first segment set includes at least one segment with a target starting probability exceeding a first threshold and/or at least one segment with a target starting probability being higher than that of at least two adjacent segments, and the second segment set includes at least one segment with a target ending probability exceeding a second threshold and/or at least one segment with a target ending probability being higher than that of at least two adjacent segments; and generating the temporal object proposal set based on the first segment set and the second segment.

In this implementation, the first segment set and the second segment set can be screened quickly and accurately, and then the temporal object proposal set can be generated according to the first segment set and the second segment set.

In an optional implementation, the method for image processing further includes: obtaining a long-term proposal feature of a first temporal object proposal based on a video feature sequence of the video stream, where a time period corresponding to the long-term proposal feature is longer than a time period corresponding to the first temporal object proposal, and the first temporal object proposal is included in the temporal object proposal set; obtaining a short-term proposal feature of the first temporal object proposal based on the video feature sequence of the video stream, where a time period corresponding to the short-term proposal feature is the same as the time period corresponding to the first temporal object proposal; and obtaining an evaluation result of the first temporal object proposal based on the long-term proposal feature and the short-term proposal feature.

In this way, interactive information between the long-term proposal feature and the short-term proposal feature as well as other multi-granularity clues can be integrated to generate rich proposal features, thereby improving the accuracy of proposal quality evaluation.

In an optional implementation, before obtaining the long-term proposal feature of the first temporal object proposal of the video stream based on the video feature sequence of the video stream, the method further includes: obtaining a target action probability sequence based on at least one of the first feature sequence or the second feature sequence; and splicing the first feature sequence and the target action probability sequence to obtain the video feature sequence.

In this implementation, by splicing the action probability sequence and the first feature sequence, a feature sequence including more feature information can be quickly obtained, so that the proposal features obtained by sampling include rich information.

In an optional implementation, obtaining the short-term proposal feature of the first temporal object proposal based on the video feature sequence of the video stream includes: performing sampling on the video feature sequence based on the time period corresponding to the first temporal object proposal to obtain the short-term proposal feature.

In this implementation, the long-term proposal feature can be extracted quickly and accurately.

In an optional implementation, obtaining the evaluation result of the first temporal object proposal based on the long-term proposal feature and the short-term proposal feature includes: obtaining a target proposal feature of the first temporal object proposal based on the long-term proposal feature and the short-term proposal feature; and obtaining the evaluation result of the first temporal object proposal based on the target proposal feature of the first temporal object proposal.

In this implementation, a proposal feature with better quality can be obtained by integrating the long-term proposal feature and the short-term proposal feature, so as to evaluate the quality of the temporal object proposal more accurately.

In an optional implementation, obtaining the target proposal feature of the first temporal object proposal based on the long-term proposal feature and the short-term proposal feature includes: performing a non-local attention operation on the long-term proposal feature and the short-term proposal feature to obtain an intermediate proposal feature; and splicing the short-term proposal feature and the intermediate proposal feature to obtain the target proposal feature.

In this implementation, through a non-local attention operation and a fusion operation, a richer proposal feature can be obtained, so as to evaluate the quality of the temporal object proposal more accurately.

In an optional implementation, obtaining the long-term proposal feature of the first temporal object proposal based on the video feature sequence of the video stream includes: obtaining the long-term proposal feature based on feature data corresponding to a reference time interval in the video feature sequence, where the reference time interval ranges from a starting time of a first temporal object in the temporal object proposal set to an ending time of a last temporal object in the temporal object proposal set.

In this implementation, the long-term proposal feature can be quickly obtained.

In an optional implementation, the method for image processing further includes: inputting the target proposal feature to a proposal evaluation network for processing to obtain at least two quality indicators of the first temporal object proposal, where a first indicator of the at least two quality indicators is used for representing a proportion of an intersection of the first temporal object proposal and a truth value in a length of the first temporal object proposal, and a second indicator of the at least two quality indicators is used for representing a proportion of the intersection of the first temporal object proposal and the truth value in a length of the truth value; and obtaining the evaluation result based on the at least two quality indicators.

In this implementation, the evaluation result is obtained according to at least two quality indicators, so that the quality of the temporal object proposal can be evaluated more accurately, and the quality of the evaluation result is higher.

In an optional implementation, the method for image processing is applied to a temporal proposal generation network, and the temporal proposal generation network includes a proposal generation network and a proposal evaluation network; a process for training the proposal generation network includes: inputting a training sample to the temporal proposal generation network for processing to obtain a sample temporal proposal set output by the proposal generation network and evaluation results of sample temporal proposals included in the sample temporal proposal set output by the proposal evaluation network; obtaining a network loss based on differences respectively between the sample temporal proposal set of the training sample and the evaluation results of the sample temporal proposals included in the sample temporal proposal set and labeling information of the training sample; and adjusting network parameters of the temporal proposal generation network based on the network loss.

In this implementation, the proposal generation network and the proposal evaluation network are jointly trained as a whole, so that the quality of proposal evaluation is steadily improved while the precision of the temporal proposal set is effectively improved, thereby ensuring the reliability of subsequent proposal retrieval.

In an optional implementation, the method for image processing is applied to a temporal proposal generation network, and the temporal proposal generation network includes a first proposal generation network, a second proposal generation network, and a proposal evaluation network; a process for training the temporal proposal generation network includes: inputting a first training sample to the first proposal generation network for processing to obtain a first sample starting probability sequence, a first sample action probability sequence, a first sample ending probability sequence, and inputting a second training sample is to the second proposal generation network for processing to obtain a second sample starting probability sequence, a second sample action probability sequence, and a second sample ending probability sequence; obtaining a sample temporal proposal set and a sample proposal feature set based on the first sample starting probability sequence, the first sample action probability sequence, the first sample ending probability sequence, the second sample starting probability sequence, the second sample action probability sequence, the second sample ending probability sequence; inputting the sample proposal feature set to the proposal evaluation network for processing to obtain at least two quality indicators of each sample proposal feature in the sample proposal feature set; determining a confidence score of the each sample proposal feature according to the at least two quality indicators of the each sample proposal feature; and updating the first proposal generation network, the second proposal generation network, and the proposal according to a weighted sum of a first loss corresponding to the first proposal generation network and the second proposal generation network and a second loss corresponding to the proposal evaluation network.

In this implementation, the first proposal generation network, the second proposal generation network, and the proposal evaluation network are jointly trained as a whole, so that the quality of proposal evaluation is steadily improved while the precision of the temporal proposal set is effectively improved, thereby ensuring the reliability of subsequent proposal retrieval.

In an optional implementation, obtaining the sample temporal proposal set and the sample proposal feature set based on the first sample starting probability sequence, the first sample action probability sequence, the first sample ending probability sequence, the second sample starting probability sequence, the second sample action probability sequence, the second sample ending probability sequence includes: fusing the first sample starting probability sequence and the second sample starting probability sequence to obtain a target sample starting probability sequence; fusing the first sample ending probability sequence and the second sample ending probability sequence to obtain a target sample ending probability sequence; and generating the sample temporal proposal set based on the target sample starting probability sequence and the target sample ending probability sequence.

In this implementation, the boundary probability of each segment in a video is evaluated in two opposite temporal directions, and a simple and effective fusion strategy is used to remove noise, so that the finally located temporal boundary has higher precision.

In an optional implementation, the first loss is any one of the following or a weighted sum of at least two of the following: a loss of the target sample starting probability sequence with respect to a real sample starting probability sequence, a loss of the target sample ending probability sequence with respect to a real sample ending probability sequence, and a loss of the target sample action probability sequence with respect to a real sample action probability sequence; and the second loss is a loss of at least one quality indicator of the each sample proposal feature with respect to a real quality indicator of the each sample proposal feature.

In this implementation, the first proposal generation network, the second proposal generation network, and the proposal evaluation network can be quickly trained.

According to a second aspect, the embodiments of the present application provide a method for proposal evaluation, including: obtaining a long-term proposal feature of a first temporal object proposal based on a video feature sequence in a video stream, where the video feature sequence includes feature data of each of multiple segments included in the video stream and an action probability sequence obtained based on the video stream, or the video feature sequence is an action probability sequence obtained based on the video stream, a time period corresponding to the long-term proposal feature is longer than a time period corresponding to the first temporal object proposal, and the first temporal object proposal is included in a temporal object proposal set obtained based on the video stream; obtaining a short-term proposal feature of the first temporal object proposal based on the video feature sequence of the video stream, where a time period corresponding to the short-term proposal feature is the same as the time period corresponding to the first temporal object proposal; and obtaining an evaluation result of the first temporal object proposal based on the long-term proposal feature and the short-term proposal feature.

In the embodiments of the present application, interactive information between the long-term proposal feature and the short-term proposal feature as well as other multi-granularity clues can be integrated to generate rich proposal features, thereby improving the accuracy of proposal quality evaluation.

In an optional implementation, before obtaining the long-term proposal feature of the first temporal object proposal based on the video feature sequence of the video stream, the method further includes: obtaining a target action probability sequence based on at least one of a first feature sequence or a second feature sequence, where the first feature sequence and the second feature sequence each include the feature data of each of the multiple segments in the video stream, and the second feature sequence and the first feature sequence comprise same feature data, but arranged in a reverse order; and splicing the first feature sequence and the target action probability sequence to obtain the video feature sequence.

In this implementation, by splicing the action probability sequence and the first feature sequence, a feature sequence including more feature information can be quickly obtained, so that the proposal features obtained by sampling include rich information.

In an optional implementation, obtaining the short-term proposal feature of the first temporal object proposal based on the video feature sequence of the video stream includes: performing sampling on the video feature sequence based on the time period corresponding to the first temporal object proposal to obtain the short-term proposal feature.

In this implementation, the short-term proposal feature can be quickly obtained.

In an optional implementation, obtaining the evaluation result of the first temporal object proposal based on the long-term proposal feature and the short-term proposal feature includes: obtaining a target proposal feature of the first temporal object proposal based on the long-term proposal feature and the short-term proposal feature; and obtaining the evaluation result of the first temporal object proposal based on the target proposal feature of the first temporal object proposal.

In this implementation, a proposal feature with better quality can be obtained by integrating the long-term proposal feature and the short-term proposal feature, so as to evaluate the quality of the temporal object proposal more accurately.

In an optional implementation, obtaining the target proposal feature of the first temporal object proposal based on the long-term proposal feature and the short-term proposal feature includes: performing a non-local attention operation on the long-term proposal feature and the short-term proposal feature to obtain an intermediate proposal feature; and splicing the short-term proposal feature and the intermediate proposal feature to obtain the target proposal feature.

In this implementation, through a non-local attention operation and a fusion operation, a richer proposal feature can be obtained, so as to evaluate the quality of the temporal object proposal more accurately.

In an optional implementation, obtaining the long-term proposal feature of the first temporal object proposal based on the video feature sequence of the video stream includes: obtaining the long-term proposal feature based on feature data corresponding to a reference time interval in the video feature sequence, where the reference time interval ranges from the starting time of the first temporal object in the temporal object proposal set to the ending time of the last temporal object in the temporal object proposal set.

In this implementation, the long-term proposal feature can be quickly obtained.

In an optional implementation, obtaining the evaluation result of the first temporal object proposal based on the target proposal feature of the first temporal object proposal includes: inputting the target proposal feature to a proposal evaluation network for processing to obtain at least two quality indicators of the first temporal object proposal, where a first indicator of the at least two quality indicators is used for representing a proportion of an intersection of the first temporal object proposal and a truth value in the length of the first temporal object proposal, and a second indicator of the at least two quality indicators is used for representing a proportion of the intersection of the first temporal object proposal and the truth value in the length of the truth value; and obtaining the evaluation result based on the at least two quality indicators.

In this implementation, the evaluation result is obtained according to at least two quality indicators, so that the quality of the temporal object proposal can be evaluated more accurately, and the quality of the evaluation result is higher.

According to a third aspect, the embodiments of the present application provide another method for proposal evaluation, including: obtaining a target action probability sequence of a video stream based on a first feature sequence of the video stream, where the first feature sequence includes feature data of each of multiple segments of the video stream; splicing the first feature sequence and the target action probability sequence to obtain a video feature sequence; and obtaining an evaluation result of the first temporal object proposal of the video stream based on the video feature sequence.

In the embodiments of the present application, the feature sequence and the target action probability sequence are spliced in channel dimension to obtain a video feature sequence including more feature information, so that the proposal features obtained by sampling include rich information.

In an optional implementation, obtaining the target action probability sequence of the video stream based on the first feature sequence of the video stream includes: obtaining a first action probability sequence based on the first feature sequence; obtaining a second action probability sequence based on a second feature sequence of the video stream, where the feature data included in the second feature sequence is the same as that included in the first feature sequence and is arranged in a reverse order; and performing fusing processing on the first action probability sequence and the second action probability sequence to obtain the target action probability sequence.

In this implementation, the boundary probability of each moment (i. e., time point) in a video is evaluated in two opposite temporal directions, and a simple and effective fusion strategy is used to remove noise, so that the finally located temporal boundary has higher precision.

In an optional implementation, performing fusing processing on the first action probability sequence and the second action probability sequence to obtain the target action probability sequence includes: performing time sequence reversal processing on the second action probability sequence to obtain a third action probability sequence; and fusing the first action probability sequence and the third action probability sequence to obtain the target action probability sequence.

In an optional implementation, obtaining the evaluation result of the first temporal object proposal of the video stream based on the video feature sequence includes: performing sampling on the video feature sequence based on a time period corresponding to the first temporal object proposal to obtain a target proposal feature; and obtaining the evaluation result of the first temporal object proposal based on the target proposal feature.

In an optional implementation, obtaining the evaluation result of the first temporal object proposal based on the target proposal feature includes: inputting the target proposal feature to a proposal evaluation network for processing to obtain at least two quality indicators of the first temporal object proposal, where a first indicator of the at least two quality indicators is used for representing a proportion of an intersection of the first temporal object proposal and a truth value in the length of the first temporal object proposal, and a second indicator of the at least two quality indicators is used for representing a proportion of the intersection of the first temporal object proposal and the truth value in the length of the truth value; and obtaining the evaluation result based on the at least two quality indicators.

In an optional implementation, before obtaining the evaluation result of the first temporal object proposal of the video stream based on the video feature sequence, the method further includes: obtaining a first object boundary probability sequence based on the first feature sequence, where the first object boundary probability sequence includes probabilities that the multiple segments belong to an object boundary; obtaining a second object boundary probability sequence based on the second feature sequence of the video stream; and generating the first temporal object proposal based on the first object boundary probability sequence and the second object boundary probability sequence.

In an optional implementation, generating the first temporal object proposal based on the first object boundary probability sequence and the second object boundary probability sequence includes: performing fusion processing on the first object boundary probability sequence and the second object boundary probability sequence to obtain a target boundary probability sequence; and generating the first temporal object proposal based on the target boundary probability sequence.

In an optional implementation, performing fusion processing on the first object boundary probability sequence and the second object boundary probability sequence to obtain the target boundary probability sequence includes: performing time sequence reversal processing on the second object boundary probability sequence to obtain a third object boundary probability sequence; and fusing the first object boundary probability sequence and the third object boundary probability sequence to obtain the target boundary probability sequence.

According to a fourth aspect, the embodiments of the present application provide another method for proposal evaluation, including: obtaining a first action probability sequence based on a first feature sequence of a video stream, where the first feature sequence includes feature data of each of multiple segments of the video stream; obtaining a second action probability sequence based on a second feature sequence of the video stream, where the feature data included in the second feature sequence is the same as that included in the first feature sequence and is arranged in a reverse order; obtaining a target action probability sequence of the video stream based on the first action probability sequence and the second action probability sequence; and obtaining an evaluation result of a first temporal object proposal of the video stream based on the target action probability sequence of the video stream.

In the embodiments of the present application, a more accurate target action probability sequence can be obtained based on the first action probability sequence and the second action probability sequence, so that the quality of the temporal object proposal can be evaluated more accurately by using the target action probability sequence.

In an optional implementation, obtaining the target action probability sequence of the video stream based on the first action probability sequence and the second action probability sequence includes: performing fusing processing on the first action probability sequence and the second action probability sequence to obtain the target action probability sequence.

In an optional implementation, performing fusing processing on the first action probability sequence and the second action probability sequence to obtain the target action probability sequence includes: performing time sequence reversal processing on the second action probability sequence to obtain a third action probability sequence; and fusing the first action probability sequence and the third action probability sequence to obtain the target action probability sequence.

In an optional implementation, obtaining the evaluation result of the first temporal object proposal of the video stream based on the target action probability sequence of the video stream includes: obtaining a long-term proposal feature of the first temporal object proposal based on the target action probability sequence, where a time period corresponding to the long-term proposal feature is longer than a time period corresponding to the first temporal object proposal; obtaining a short-term proposal feature of the first temporal object proposal based on the target action probability sequence, where a time period corresponding to the short-term proposal feature is the same as the time period corresponding to the first temporal object proposal; and obtaining an evaluation result of the first temporal object proposal based on the long-term proposal feature and the short-term proposal feature.

In an optional implementation, obtaining the long-term proposal feature of the first temporal object proposal based on the target action probability sequence includes: performing sampling on the target action probability sequence to obtain the long-term proposal feature.

In an optional implementation, obtaining the obtaining the short-term proposal feature of the first temporal object proposal based on the target action probability sequence includes: performing sampling on the target action probability sequence based on the time period corresponding to the first temporal object proposal to obtain the short-term proposal feature.

In an optional implementation, obtaining the evaluation result of the first temporal object proposal based on the long-term proposal feature and the short-term proposal feature includes: obtaining a target proposal feature of the first temporal object proposal based on the long-term proposal feature and the short-term proposal feature; and obtaining the evaluation result of the first temporal object proposal based on the target proposal feature of the first temporal object proposal.

In an optional implementation, obtaining the target proposal feature of the first temporal object proposal based on the long-term proposal feature and the short-term proposal feature includes: performing a non-local attention operation on the long-term proposal feature and the short-term proposal feature to obtain an intermediate proposal feature; and splicing the short-term proposal feature and the intermediate proposal feature to obtain the target proposal feature.

According to a fifth aspect, the embodiments of the present application provide an image processing apparatus, including:

an acquisition unit, configured to acquire a first feature sequence of a video stream, where the first feature sequence includes feature data of each of multiple segments of the video stream;

a processing unit, configured to obtain a first object boundary probability sequence based on the first feature sequence, where the first object boundary probability sequence includes probabilities that the multiple segments belong to an object boundary;

the processing unit, further configured to obtain a second object boundary probability sequence based on a second feature sequence of the video stream, where the second feature sequence and the first feature sequence comprise same feature data, but arranged in a reverse order; and

a generation unit, configured to generate a temporal object proposal set based on the first object boundary probability sequence and the second object boundary probability sequence.

According to a sixth aspect, the embodiments of the present application provide a method for proposal evaluation, including: a feature determination unit, configured to obtain a long-term proposal feature of a first temporal object proposal based on a video feature sequence of a video stream, where the video feature sequence includes feature data of each of multiple segments included in the video stream and an action probability sequence obtained based on the video stream, or the video feature sequence is an action probability sequence obtained based on the video stream, a time period corresponding to the long-term proposal feature is longer than a time period corresponding to the first temporal object proposal, and the first temporal object proposal is included in a temporal object proposal set obtained based on the video stream; the feature determination unit, further configured to obtain a short-term proposal feature of the first temporal object proposal based on the video feature sequence of the video stream, where a time period corresponding to the short-term proposal feature is the same as the time period corresponding to the first temporal object proposal; and an evaluation unit, configured to obtain an evaluation result of the first temporal proposal based on the long-term proposal feature and the short-term proposal feature.

According to a seventh aspect, the embodiments of the present application provide another proposal evaluation apparatus, including: a processing unit, configured to obtain a target action probability sequence of a video stream based on a first feature sequence of the video stream, where the first feature sequence includes feature data of each of multiple segments of the video stream; a splicing unit, configured to splice the first feature sequence and the target action probability sequence to obtain a video feature sequence; and an evaluation unit, configured to obtain an evaluation result of the first temporal object proposal of the video stream based on the video feature sequence.

According to an eighth aspect, the embodiments of the present application provide another proposal evaluation apparatus, including: a processing unit, configured to obtain a first action probability sequence based on a first feature sequence of a video stream, where the first feature sequence includes feature data of each of multiple segments of the video stream; obtain a second action probability sequence based on a second feature sequence of the video stream, where the second feature sequence and the first feature sequence comprise same feature data, but arranged in a reverse order; and obtain a target action probability sequence of the video stream based on the first action probability sequence and the second action probability sequence; and an evaluation unit, configured to obtain an evaluation result of a first temporal object proposal of the video stream based on the target action probability sequence of the video stream.

According to a ninth aspect, the embodiments of the present application provide an electronic device, including: a memory, configured to store a program; and a processor, configured to execute the program stored on the memory, where when the program is executed, the processor is configured to implement the method according to the first to fourth aspects and any one of optional implementations.

According to a tenth aspect, the embodiments of the present application provide a chip, including a processor and a data interface, where the processor reads instructions stored on a memory via the data interface to implement the method according to the first to fourth aspects and any one of optional implementations.

According to an eleventh aspect, the embodiments of the present application provide a computer-readable storage medium, storing a computer program, where the computer program includes program instructions, and when the program instructions are executed by a processor, the processor implements the method according to the first to third aspects and any one of optional implementations.

According to a twelfth aspect, the embodiments of the present application provide a computer program, including program instructions, where the program instructions are executed by a processor, the processor implements the method according to the first to third aspects and any one of optional implementations.

### BRIEF DESCRIPTION OF THE DRAWINGS

To describe the technical solutions in embodiments of the present invention more clearly, the accompanying drawings required for describing the embodiments of the present invention or the background art are described below.

FIG. 1 is a flowchart of a method for image processing provided in embodiments of the present application;

FIG. 2 is a schematic diagram of a process for generating a temporal object proposal set provided in embodiments of the present application;

FIG. 3 is a schematic diagram of a sampling process provided in embodiments of the present application;

FIG. 4 is a schematic diagram of a calculation process of a non-local attention operation provided in embodiments of the present application;

FIG. 5 is a schematic structural diagram of an image processing apparatus provided in embodiments of the present application;

FIG. 6 is a flowchart of a method for proposal evaluation provided in embodiments of the present application;

FIG. 7 is a flowchart of another method for proposal evaluation provided in embodiments of the present application;

FIG. 8 is a flowchart of still another method for proposal evaluation provided in embodiments of the present application;

FIG. 9 is a schematic structural diagram of another image processing apparatus provided in embodiments of the present application;

FIG. 10 is a schematic structural diagram of a proposal evaluation apparatus provided in embodiments of the present application;

FIG. 11 is a schematic structural diagram of another proposal evaluation apparatus provided in embodiments of the present application;

FIG. 12 is a schematic structural diagram of still another proposal evaluation apparatus provided in embodiments of the present application; and

FIG. 13 is a schematic structural diagram of a server provided in embodiments of the present application.

### DETAILED DESCRIPTION

To make a person skilled in the art better understand the solutions of embodiments of the present application, the technical solutions in the embodiments of the present application are clearly described below with reference to the accompanying drawings in the embodiments of the present application. Apparently, the described embodiments are merely some of the embodiments of the present application, but not all the embodiments.

The terms “first”, “second”, and “third”, and in the embodiments of the description and the claims as well as the accompanying drawings of the present application are used for distinguishing similar objects, rather than describing specific sequences or orders. In addition, terms “include” and “have” and any deformation thereof aim at covering non-exclusive “comprising”, for example, a method, system, product or device including a series of steps or units is not limited to those steps or units clearly listed, but may include other steps or units that are not clearly listed or inherent to the process, method, product, or device.

It should be understood that the embodiments of the present disclosure may be applied to the generation and evaluation of various temporal object proposals, for example, a time period in which a specific person appearing in a video stream is detected or a time period in which an action appearing in a video stream is detected, etc. For ease of understanding, the following examples are all described by action proposals. However, no limitation is made thereto in the embodiments of the present disclosure.

The temporal action detection task aims to locate the specific time of occurrence of an action in a long untrimmed video and the category thereof. A major difficulty in this type of problem is the quality of the generated temporal action proposal. By using current mainstream temporal action proposal generation methods, high-quality temporal action proposals cannot be obtained. Therefore, it is required to study new temporal proposal generation methods to obtain high-quality temporal action proposals. According to the technical solutions provided in the embodiments of the present application, the action probability or boundary probability at any moment in a video is evaluated in two or more time sequences, and the obtained multiple evaluation results (action probabilities or boundary probabilities) are fused to obtain high-quality probability sequences to generate a high-quality temporal object proposal set (also referred to as a candidate proposal set).

The temporal proposal generation method provided in the embodiments of the present application can be applied to scenarios such as intelligent video analysis and security surveillance. The following simply describes the application of the temporal proposal generation method provided in the embodiments of the present application in the intelligent video analysis scenario and the security surveillance scenario respectively.

In the intelligent video analysis scenario, for example, an image processing apparatus, such as a server, processes a feature sequence extracted from a video to obtain a candidate proposal set and confidence scores of proposals in the candidate proposal set; and performing temporal action localization according to the candidate proposal set and the confidence scores of the proposals in the candidate proposal set, so as to extract highlights (such as a fighting segment) in the video. For another example, an image processing apparatus, such as a server, performs temporal action detection on a video that a user has viewed so as to predict the type of video the user likes, and recommending similar videos to the user.

In the security surveillance scenario, for example, an image processing apparatus processes a feature sequence extracted from a surveillance video to obtain a candidate proposal set and confidence scores of proposals in the candidate proposal set; and performing temporal action localization according to the candidate proposal set and the confidence scores of the proposals in the candidate proposal set, so as to extract segments including certain temporal actions in the surveillance video. For example, the segments of vehicles entering and exiting are extracted from the surveillance video at a certain intersection. For another example, temporal action detection is performed on multiple surveillance videos, so as to find videos including certain temporal actions, such as an action that a vehicle hitting a person, from the multiple surveillance videos.

In the scenario above, by using the temporal proposal generation method provided in the present application, a high-quality temporal object proposal set can be obtained, so as to efficiently complete the temporal action detection task. The following description of the technical solutions takes temporal actions as an example. However, the embodiments of the present disclosure can also be applied to other types of temporal object detection, and no limitation is made thereto in the embodiments of the present disclosure.

Referring to FIG. 1, FIG. 1 is a method for image processing provided in embodiments of the present application.

At 101, a first feature sequence of a video stream is acquired.

The first feature sequence includes feature data of each of multiple segments of the video stream. The execution subject of the embodiments of the present application is an image processing apparatus, such as a server, a terminal device, or other computer devices. Acquiring the first feature sequence of the video stream may be that the image processing apparatus performs feature extraction on each of the multiple segments included in the video stream according to a time sequence of the video stream to obtain the first feature sequence. In some embodiments, the first feature sequence may be an original two-stream feature sequence obtained by performing feature extraction on the video stream by the image processing apparatus by using a two-stream network. Or the first feature sequence is obtained by performing feature extraction on the video stream by the image processing apparatus by using other types of neural networks, or the first feature sequence is obtained by the image processing apparatus from other terminals or network devices. No limitation is made thereto in the embodiments of the present disclosure.

At 102, a first object boundary probability sequence is obtained based on the first feature sequence.

The first object boundary probability sequence includes probabilities that the multiple segments belong to an object boundary, for example, a probability that each of the multiple segments belongs to the object boundary. In some embodiments, the first feature sequence may be input to a proposal generation network for processing to obtain the first object boundary probability sequence. The first object boundary probability sequence may include a first starting probability sequence and a first ending probability sequence. Each starting probability in the first starting probability sequence represents a probability that a certain segment of the multiple segments included in the video stream corresponds to a starting action, i. e., a probability that a certain segment is an action starting segment. Each ending probability in the first ending probability sequence represents a probability that a certain segment of the multiple segments included in the video stream corresponds to an ending action, i. e., a probability that a certain segment is an action ending segment.

At 103, a second object boundary probability sequence is obtained based on a second feature sequence of the video stream.

The feature data included in the second feature sequence is the same as that included in the first feature sequence and is arranged in a reverse order. For example, the first feature sequence sequentially includes the first feature to the M^{th} feature, and the second feature sequence sequentially includes the M^{th} feature to the first feature, where M is an integer greater than 1. Optionally, in some embodiments, the second feature sequence may be a feature sequence obtained by reversing the time sequence of the feature data in the first feature sequence, or obtained by performing other further processing after the reversal. Optionally, before performing step 103, the image processing apparatus performs time sequence reversal processing the first feature sequence to obtain the second feature sequence. Or the second feature sequence is obtained in other manners, and no limitation is made thereto in the embodiments of the present disclosure.

In some embodiments, the second feature sequence may be input to a proposal generation network for processing to obtain the second object boundary probability sequence. The second object boundary probability sequence may include a second starting probability sequence and a second ending probability sequence. Each starting probability in the second starting probability sequence represents a probability that a certain segment of the multiple segments included in the video stream corresponds to a starting action, i. e., a probability that a certain segment is an action starting segment. Each ending probability in the second ending probability sequence represents a probability that a certain segment of the multiple segments included in the video stream corresponds to an ending action, i. e., a probability that a certain segment is an action ending segment. In this way, the first starting probability sequence and the second starting probability sequence include starting probabilities corresponding to multiple same segments. For example, the first starting probability sequence sequentially includes starting probabilities corresponding to the first segment to the N^{th} segment, and the second starting probability sequence sequentially includes starting probabilities corresponding to the N^{th} segment to the first segment. Similarly, the first ending probability sequence and the second ending probability sequence include ending probabilities corresponding to multiple same segments. For example, the first ending probability sequence sequentially includes ending probabilities corresponding to the first segment to the Nth segment, and the second ending probability sequence sequentially includes ending probabilities corresponding to the N^{th} segment to the first segment.

At 104, a temporal object proposal set is generated based on the first object boundary probability sequence and the second object boundary probability sequence.

In some embodiments, fusing processing is performed on the first object boundary probability sequence and the second object boundary probability sequence to obtain a target boundary probability sequence; and the temporal object proposal set is generated based on the target boundary probability sequence. For example, time sequence reversal processing is performed on the second object boundary probability sequence to obtain a third object boundary probability sequence; and the first object boundary probability sequence and the third object boundary probability sequence are fused to obtain the target boundary probability sequence. For another example, time sequence reversal processing is performed on the first object boundary probability sequence to obtain a fourth object boundary probability sequence; and the second object boundary probability sequence and the fourth object boundary probability sequence are fused to obtain the target boundary probability sequence.

In the embodiments of the present application, the temporal object proposal set is generated based on the fused probability sequences, and a probability sequence with a more precise boundary can be obtained, so that the boundary of the generated temporal object proposal is more precise.

A specific implementation of operation 101 is described below.

In some embodiments, the image processing apparatus uses two proposal generation networks to process the first feature sequence and the second feature sequence, for example, the image processing apparatus inputs the first feature sequence to the first proposal generation network for processing to obtain the first object boundary probability sequence and inputs the second feature sequence to the second proposal generation network for processing to obtain the second object boundary probability sequence. The first proposal generation network and the second proposal generation network may be the same or different. Optionally, the structure and parameter configuration of the first proposal generation network are the same as those of the second proposal generation network, and the image processing apparatus may use the two networks to process the first feature sequence and the second feature in parallel or in any order, or the first proposal generation network and the second proposal generation network have the same hyperparameters, while network parameters are learned during a training process, and their values can be the same or different.

In other embodiments, the image processing apparatus may use the same proposal generation network to serially process the first feature sequence and the second feature sequence. For example, the image processing apparatus first inputs the first feature sequence to the proposal generation network for processing to obtain the first object boundary probability sequence, and then inputs the second feature sequence to the proposal generation network for processing to obtain the second object boundary probability sequence.

In the embodiments of the present disclosure, the proposal generation network optionally includes three temporal convolutional layers, or includes other numbers of convolutional layers and/or other types of processing layers. Each temporal convolutional layer is defined as Conv(n_{f}, k, Act) , where n_{f}, k, and Act represent the number of convolution kernels, the size of a convolution kernel, and an activation function respectively. In an example, for the first two temporal convolutional layers in each proposal generation network, n_{f} is 512, k is 3, and a Rectified Linear Unit (ReLU) is used as the activation function; and for the last temporal convolutional layer, n_{f} is 3, k is 1, and the Sigmoid activation function is used for predicted output. However, the specific implementation of the proposal generation network is not limited in the embodiments of the present disclosure.

In this implementation, the image processing apparatus processes the first feature sequence and the second feature sequence separately, so as to fuse the two object boundary probability sequences obtained by the processing to obtain a more accurate object boundary probability sequence.

The following describes how to perform fusion processing on the first object boundary probability sequence and the second object boundary probability sequence to obtain the target boundary probability sequence.

In an optional implementation, each of the first object boundary probability sequence and the second object boundary probability sequence includes a starting probability sequence and an ending probability sequence. Accordingly, fusion processing is performed on the starting probability sequences in the first object boundary probability sequence and the second object boundary probability sequence to obtain a target starting probability sequence; and/or, the ending probability sequences in the first object boundary probability sequence and the second object boundary probability sequence to obtain a target ending probability sequence, where the target boundary probability sequence includes at least one of the target starting probability sequence and the target ending probability sequence.

In an optional example, the order of the probabilities in the second starting probability sequence is reversed to obtain a reference starting probability sequence, where the probabilities in the first starting probability sequence sequentially correspond to the probabilities in the reference starting probability sequence; and the first starting probability sequence and the reference starting probability sequence are fused to obtain the target starting probability sequence. For example, the first starting probability sequence sequentially includes starting probabilities corresponding to the first segment to the N^{th} segment, the second starting probability sequence sequentially includes starting probabilities corresponding to the N^{th} segment to the first segment, and the reference starting probability sequence obtained by reversing the order of the probabilities in the second starting probability sequence sequentially includes the starting probabilities corresponding to the first segment to the N^{th} segment; and average values of the starting probabilities corresponding to the first segment to the N^{th} segment in the first starting probability sequence and the reference starting probability sequence are sequentially taken as starting probabilities corresponding to the first segment to the N^{th} segment in the target starting probability to obtain the target starting probability sequence, that is to say, an average value of a starting probability corresponding to the i^{th} segment in the first starting probability sequence and a starting probability corresponding to the i^{th} segment in the reference starting probability sequence is taken as a starting probability corresponding to the i^{th} segment in the target starting probability, where i=1, . . . , N.

Similarly, in an optional implementation, the order of the probabilities in the second ending probability sequence is reversed to obtain a reference ending probability sequence, the probabilities in the first ending probability sequence subsequently correspond to the probabilities in the reference ending probability sequence; and the first ending probability sequence and the reference ending probability sequence are fused to obtain the target ending probability sequence. For example, the first ending probability sequence sequentially includes ending probabilities corresponding to the first segment to the N^{th} segment, the second ending probability sequence sequentially includes ending probabilities corresponding to the N^{th} segment to the first segment, and the reference ending probability sequence obtained by reversing the order of the probabilities in the second ending probability sequence sequentially includes the ending probabilities corresponding to the first segment to the N^{th} segment; and average values of the ending probabilities corresponding to the first segment to the N^{th} segment in the first ending probability sequence and the reference ending probability sequence are sequentially taken as ending probabilities corresponding to the first segment to the N^{th} segment in the target ending probability to obtain the target ending probability sequence.

Optionally, the starting probabilities or the ending probabilities in the two probability sequences may also be fused in other manners, and no limitation is made thereto in the embodiments of the present disclosure.

In the embodiments of the present application, by performing fusing processing on the two object boundary sequences, an object boundary probability sequence with a more accurate boundary can be obtained, thereby generating a temporal object proposal set with higher quality.

The following describes a specific implementation for generating a temporal object proposal set based on the target boundary probability sequence.

In an alternative implementation, the target boundary probability sequence includes a target starting probability sequence and a target ending probability sequence. Accordingly, the temporal object proposal set is generated based on the target starting probability sequence and the target ending probability sequence included in the target boundary probability sequence.

In another optional implementation, the target boundary probability sequence includes a target starting probability sequence. Accordingly, the temporal object proposal set is generated based on the target starting probability sequence included in the target boundary probability sequence and the ending probability sequence included in the first object boundary probability sequence; or the temporal object proposal set is generated based on the target starting probability sequence included in the target boundary probability sequence and the ending probability sequence included in the second object boundary probability sequence.

In another optional implementation, the target boundary probability sequence includes a target ending probability sequence. Accordingly, the temporal object proposal set is generated based on the starting probability sequence included in the first object boundary probability sequence and the target ending probability sequence included in the target boundary probability sequence; or the temporal object proposal set is generated based on the starting probability sequence included in the second object boundary probability sequence and the target ending probability sequence included in the target boundary probability sequence.

The following uses the target starting probability sequence and target ending probability sequence as examples to describe a method for generating the temporal object proposal set.

Optionally, a first segment set is obtained based on target starting probabilities of the multiple segments included in the target starting probability sequence, where the first segment set includes multiple object starting segments; a second segment set is obtained based on target ending probabilities of the multiple segments included in the target ending probability sequence, where the second segment set includes multiple object ending segments; and the temporal object proposal set is generated based on the first segment set and the second segment set.

In some examples, an object starting segment is selected from the multiple segments based on the target starting probability of each of the multiple segments, for example, a segment with the target starting probability exceeding a first threshold is used as the object starting segment, or a segment with the highest target starting probability in a local region as the target starting segment, or a segment with the target starting probability higher than the target starting probabilities of at least two adjacent segments as the target starting segment, or a segment with the target starting probability higher than the target starting probabilities of the previous segment and the subsequent segment is used as the target starting segment, etc. A specific implementation for determining the target starting segment is not limited in the embodiments of the present disclosure.

In some examples, an object ending segment is selected from the multiple segments based on the target ending probability of each of the multiple segments, for example, a segment with the target ending probability exceeding a first threshold is used as the object ending segment, or a segment with the highest target ending probability in a local region as the target ending segment, or a segment with the target ending probability higher than the target ending probabilities of at least two adjacent segments as the target ending segment, or a segment with the target ending probability higher than the target ending probabilities of the previous segment and the subsequent segment is used as the target ending segment, etc. A specific implementation for determining the target ending segment is not limited in the embodiments of the present disclosure.

In an optional implementation, a time point corresponding to a segment in the first segment set is taken as a starting time point of a temporal object proposal, and a time point corresponding to a segment in the second segment set is taken as an ending time point of the temporal object proposal. For example, if a segment in the first segment set corresponds to a first time point, and a segment in the second segment set corresponds to a second time point, a temporal object proposal includes in the temporal object proposal set generated based on the first segment set and the second segment set is [the first time point, the second time point]. The first threshold may be 0.7, 0.75, 0.8, 0.85, 0.9, etc. The second threshold may be 0.7, 0.75, 0.8, 0.85, 0.9, etc.

Optionally, a first time point set is obtained based on the target starting probability sequence, and a second time point set is obtained based on the target ending probability sequence, where the first set time point sets includes time points and/or at least one local time point with the corresponding probabilities in the target starting probability sequence exceeding a first threshold, and the corresponding probability of any local time point in the target starting probability sequence is higher than the corresponding probability of a time point adjacent to the any local time point in the target starting probability sequence; the second time point set includes time points and/or at least one reference time point with the corresponding probability in the target ending probability sequence exceeding a second threshold, and the corresponding probability of any reference time point in the target ending probability sequence is higher than the corresponding probability of a time point adjacent to the any reference time point in the target ending probability sequence; and the temporal proposal set is generated based on the first time point set and the second time point set, where the starting time point of any proposal in the temporal proposal set is a time point in the first time point set, and the ending time point of the any proposal is a time point in the second time point set; the starting time point is before the ending time point.

The first threshold may be 0.7, 0.75, 0.8, 0.85, 0.9, etc. The second threshold may be 0.7, 0.75, 0.8, 0.85, 0.9, etc. The first threshold and the second threshold may be the same or different. Any local time point may be a time point with the corresponding probability in the target starting probability sequence being higher than both a probability corresponding to its previous time point and a probability corresponding to its subsequent time point. Any reference time point may be a time point with the corresponding probability in the target ending probability sequence being higher than both a probability corresponding to its previous time point and a probability corresponding to its subsequent time point. A process for generating the temporal object proposal set may be understood as the following: at first, selecting at least one time point in both the target starting probability sequence and the target ending probability sequence that satisfies one of the following two conditions as a candidate temporal boundary node (including a candidate starting time point and a candidate ending time point): (1) the probability of the time point is higher than a threshold, (2) the probability of the time point is higher than the probability of its one or more previous time points and higher than its one or more subsequent time points (i. e., a time point corresponding to a probability peak); and then, combining the candidate starting time points and the candidate ending time points pairwise, and reserving a combination of a candidate starting time point and a candidate ending time point of which time period satisfies the requirement for a temporal action proposal. The combination of the candidate starting time point and the candidate ending time point of which time period satisfies the requirements may be a combination with the candidate starting time point being before the candidate ending time point, or be a combination with an interval between the candidate starting time point and the candidate ending time point being more than a third threshold and less than a fourth threshold, where the third threshold and the fourth threshold may be configured according to actual requirements, for example, the third threshold is 1 ms, and the fourth threshold is 100 ms.

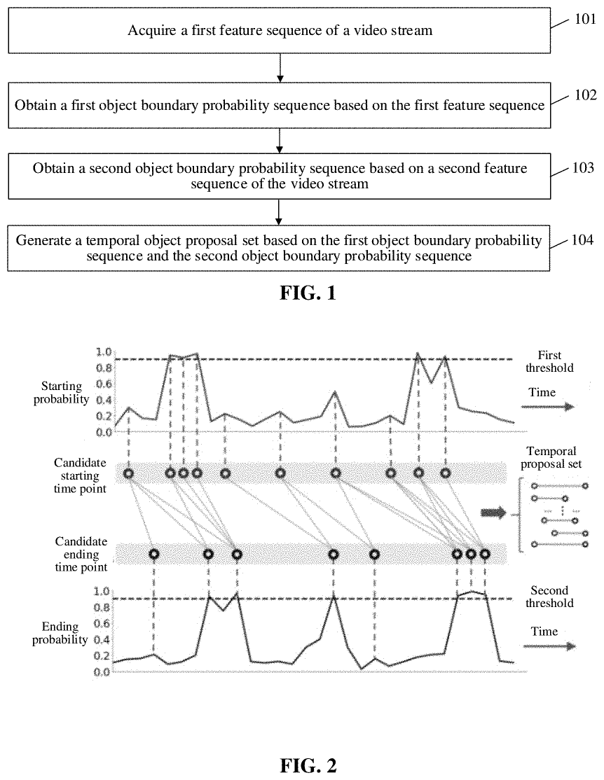

The candidate starting time point is a time point included in the first time point set, and the candidate ending time point is a time point included in the second time point set. FIG. 2 is a schematic diagram of a process for generating a temporal object proposal set provided in embodiments of the present application. As shown in FIG. 2, the starting time points with corresponding probabilities exceeding a first threshold and the time points corresponding to a probability peak are candidate starting time points; the ending time points with corresponding probabilities exceeding a second threshold and the time points corresponding to a probability peak are candidate ending time points. Each connection line in FIG. 2 corresponds to a temporal proposal (i. e., a combination of a candidate starting time point and a candidate ending time point). In each temporal proposal, the candidate starting time point is located before the candidate ending time point, and a time interval between the candidate starting point and the candidate ending time point satisfies duration requirements.

In this implementation, a temporal object proposal set can be generated quickly and accurately.

The foregoing embodiments describe a method for generating a temporal object proposal set. In practical application, after the temporal object proposal set is obtained, it is usually required to perform quality evaluation on each temporal object proposal, and the temporal object proposal set is output based on a quality evaluation result. The following describes a method for evaluating the quality of temporal object proposals.

In an optional implementation, a proposal feature set is obtained, where the proposal feature set includes proposal features of each temporal object proposal in a temporal object proposal set; the proposal feature set is input to a proposal evaluation network for processing to obtain at least two quality indicators of the each proposal object proposal in the temporal object proposal set; and an evaluation result (such as a confidence score) of the each temporal object proposal is obtained based on the at least two quality indicators of the each temporal object proposal.

Optionally, the proposal evaluation network may be a neural network, and the proposal evaluation network is used for processing the each proposal feature in the proposal feature set to obtain at least two quality indicators of the each temporal object proposal; the proposal evaluation network may also include two or more parallel proposal evaluation sub-networks, and each proposal evaluation sub-network is used for determining a quality indicator corresponding to the each corresponding temporal proposal. For example, the proposal evaluation network includes three parallel proposal evaluation sub-networks, i. e., a first proposal evaluation sub-network, a second proposal evaluation sub-network, and a third proposal evaluation sub-network, and each proposal evaluation sub-network includes three fully connected layers, of which the first two fully connected layers each includes 1024 units used for processing input proposal features, and Relu is used as the activation function, and the third fully connected layer includes an output node, which outputs a corresponding prediction result through the Sigmoid activation function. The first proposal evaluation sub-network outputs a first indicator that reflects the overall quality of a temporal proposal (i. e., a proportion of an intersection of the temporal proposal and a truth value in a union thereof), the second proposal evaluation sub-network outputs a second indicator that reflects the completeness quality of the temporal proposal (i. e., a proportion of the intersection of the temporal proposal and the truth value in the length of the temporal proposal), and the third proposal evaluation sub-network outputs a third indicator that reflects the action quality of the temporal proposal (the proportion of the intersection of the temporal proposal and the truth value in the length of the truth value). IoU, IoP, and IoG may sequentially represent the first indicator, the second indicator, and the third indicator. The loss function corresponding to the proposal evaluation network may be as follows:

L_{PSM}=λ_{IoU}·L_{PSM}^{IoU}+λ_{IoP}·L_{PSM}^{IoP}+λ_{IoG}·L_{PSM}^{IoG} (1);

where λ_{IoU} , λ_{IoP} , and λ_{IoG} are weighting factors and may be configured according to actual situations. L_{PSM}^{IoU}, L_{PSM}^{IoP}, and L_{PSM}^{IoG} sequentially represent the losses of the first indicator (IoU), the second indicator (IoP), and the third indicator (IoG). L_{PSM}^{IoU}, L_{PSM}^{IoP}, and L_{PSM}^{IoG} may all be calculated by using the smooth_{L1} loss function or other loss functions. The definition of the smooth_{L1} loss function is as follows:

$${smooth}_{L 1} = \{ \begin{matrix}0.5 {x}^{2} if \vert x \vert < 1 \\ \vert x \vert - 0. 5 o t herwise\end{matrix} ; \qquad ( 2 )$$

where for L_{PSM}^{IoU}, x in (2) is IoU; for L_{PSM}^{IoP}, x in (2) is IoP; and for L_{PSM}^{IoG}, x in (2) is IoG. According to the definitions of IoU, IoP, and IoG, an image processing apparatus may additionally calculate

$$I o {U}^{′} = \frac{IoP \cdot IoG}{IoP + IoG - IoP \cdot IoG}$$

from IoP and IoG, and then obtains a localization score p_{loc}=α·p_{IoU}+(1−α)·p_{IoU′}, where p_{IoU} represents IoU of the temporal proposal and p_{IoU′} represents IoU′ of the temporal proposal. That is to say, p_{IoU′} is IoU′ and p_{IoU} is IoU. α may be set to 0.6 or set to other constants. The image processing apparatus may calculate the confidence score of the proposal by using the following formula:

p_{conf}=hₜ_{ₛ}^{s}·hₜ_{ₑ}^{e}·p_{loc}(3);

where hₜ_{ₛ}^{s} represents a starting probability corresponding to the temporal proposal and hₜ_{ₑ}^{e} represents an ending probability corresponding to the temporal proposal.

The following describes the method how the image processing apparatus obtains a proposal feature set.

Optionally, obtaining a proposal feature set may include: splicing a first feature sequence and a target action probability sequence in channel dimension to obtain a video feature sequence; obtaining a target video feature sequence corresponding to a first temporal object proposal in the video feature sequence, where the first temporal object proposal is included in the temporal object proposal set, and a time period corresponding to the first temporal object proposal is the same as a time period corresponding to the target video feature sequence; and performing sampling on the target video feature sequence to obtain a target proposal feature, where the target proposal feature is a proposal feature of the first temporal object proposal, and is included in the proposal feature set.

Optionally, the target action probability sequence may be a first action probability sequence obtained by processing the first feature sequence input into the first proposal generation network, or a second action probability sequence obtained by the second feature sequence input into the second proposal generation network, or a probability sequence obtained by fusing the first action probability sequence and the second action probability sequence. The first proposal generation network, the second proposal generation network, and the proposal evaluation network may be jointly trained as a network. The first feature sequence and the target action probability sequence may each correspond to a three-dimensional matrix. The first feature sequence and the target action probability sequence include the same or different number of channels, and the corresponding two-dimensional matrix on each channel has the same size. Therefore, the first feature sequence and the target action probability sequence may be sliced in channel dimension to obtain the video feature sequence. For example, if the first feature sequence corresponds to a three-dimensional matrix including 400 channels, and the target action probability sequence corresponds to a two-dimensional matrix (which may be understood as a three-dimensional matrix including one channel), the video feature sequence corresponds to a three-dimensional matrix including 401 channels.

The first temporal object proposal is any temporal object proposal in the temporal object proposal set. It may be understood that the image processing apparatus may determine a proposal feature of each temporal object proposal in the temporal object proposal set in the same manner. The video feature sequence includes feature data extracted by the image processing apparatus from multiple segments included in a video stream. Obtaining the target video feature sequence corresponding to the first temporal object proposal in the video feature sequence may be obtaining the target video feature sequence corresponding to a time period corresponding to the first temporal object proposal in the video feature sequence. For example, if the time period corresponding to the first temporal object proposal is from the P milliseconds to the Q milliseconds, a sub-feature sequence corresponding to the P milliseconds to the Q milliseconds in the video feature sequence is the target video feature sequence. Both P and Q are real numbers greater than 0. Performing sampling on the target video feature sequence to obtain the target proposal feature may be: performing sampling on the target video feature sequence to obtain the target proposal feature with a target length. It may be understood that the image processing apparatus performs sampling on a video feature sequence corresponding to each temporal object proposal to obtain a proposal feature with a target length. That is to say, the proposal features of temporal object proposals have the same length. The proposal feature nominated of the each temporal object proposal corresponds to a matrix including multiple channels, and a one-dimensional matrix with a target length is included on each channel For example, the video feature sequence corresponds to a three-dimensional matrix including 401 channels, the proposal feature of the each temporal object proposal corresponds to a two-dimensional matrix with T_{S} rows and 401 columns, and it may be understood that each row corresponds to one channel T_{S} is the target length and T_{S} may be 16.

In this way, the image processing apparatus may obtain proposal features with a fixed length according to the temporal proposals with different durations, and this is simple to implement.

Optionally, obtaining the proposal feature set may also include: splicing the first feature sequence and the target action probability sequence in channel dimension to obtain a video feature sequence; obtaining a long-term proposal feature of the first temporal object proposal based on the video feature sequence, where a time period corresponding to the long-term proposal feature is longer than a time period corresponding to the first temporal object proposal, and the first temporal object proposal is included in the temporal object proposal set; obtaining a short-term proposal feature of the first temporal object proposal based on the video feature sequence, where a time period corresponding to the short-term proposal feature is the same as the time period corresponding to the first temporal object proposal; and obtaining a target proposal feature of the first temporal object proposal based on the long-term proposal feature and the short-term proposal feature. The image processing apparatus may obtain a target action probability sequence based on at least one of the first feature sequence and the second feature sequence. The target action probability sequence may be a first action probability sequence obtained by processing the first feature sequence input into the first proposal generation network, or a second action probability sequence obtained by the second feature sequence input into the second proposal generation network, or a probability sequence obtained by fusing the first action probability sequence and the second action probability sequence.

Obtaining the long-term proposal feature of the first temporal object proposal based on the video feature sequence may be: obtaining the long-term proposal feature based on feature data corresponding to a reference time interval in the video feature sequence, where the reference time interval is from the starting time of the first temporal object in the temporal object proposal set to the ending time of the last temporal object in the temporal object proposal set. The long-term proposal feature may be a matrix including multiple channels, and a one-dimensional matrix with a length of T_{L} is included on each channel For example, a long-term proposal feature is a two-dimensional matrix with T_{L} rows and 401 columns, and it may be understood that each row corresponds to one channel. T_{L} is an integer greater than T_{S}. For example, T_{S} is 16 and T_{L} is 100. Performing sampling on the video feature sequence to obtain the long-term proposal feature may be performing sampling on a feature within the reference time interval in the video feature sequence to obtain the long-term proposal feature; the reference time interval corresponds to the starting time of the first action and the ending time of the last action determined based on the temporal object proposal set. FIG. 3 is a schematic diagram of a sampling process provided in embodiments of the present application. As shown in FIG. 3, a reference time interval includes a starting region 301, a center region 302, and an ending region 303. The starting segment of the center region 302 is the starting segment of the first action, and the ending segment of the center region 302 is the ending segment of the last action. The durations corresponding to the starting region 301 and the ending region 303 are both one tenth of the duration corresponding to the center region 302. 304 represents a long-term temporal feature obtained by sampling.

In some embodiments, obtaining a short-term temporal feature of a first temporal object proposal based on a video feature sequence may be: performing sampling on the video feature sequence based on a time period corresponding to the first temporal object proposal obtain the short-term proposal feature. Herein, the method for performing sampling on the video feature sequence to obtain the short-term proposal feature is similar to the method for performing sampling on the video feature sequence to obtain the long-term proposal feature. Details are not described herein again.

In some embodiments, obtaining a target proposal feature of the first temporal object proposal based on the long-term proposal feature and the short-term proposal feature may be: performing a non-local attention operation on the long-term proposal feature and the short-term proposal feature to obtain an intermediate proposal feature; and splicing the short-term proposal feature and the intermediate proposal feature o obtain the target proposal feature.

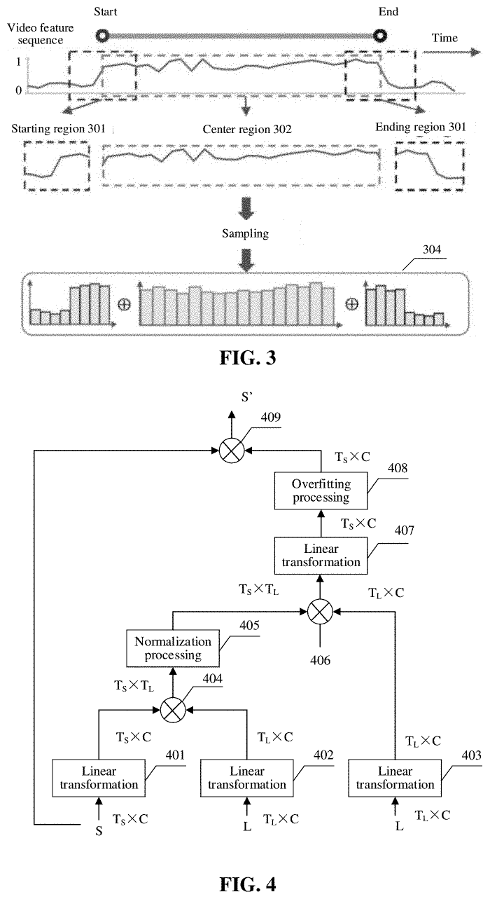

FIG. 4 is a schematic diagram of a calculation process of a non-local attention operation provided in embodiments of the present application. As shown in FIG. 4, S represents a short-term proposal feature, L represents a long-term proposal feature, C (an integer greater than 0) corresponds to the number of channels, 401 to 403 and 407 all represent linear transformation operations, 405 represents normalization processing, 404 and 406 represent matrix multiplication operations, 408 represents overfitting processing, and 409 represents a summation operation. At step 401, perform linear transformation on the short-term proposal feature; at step 402, perform linear transformation on the long-term proposal feature; at step 403, perform linear transformation on the long-term proposal feature; at step 404, calculate the product of a two-dimensional matrix of (T_{S}×C) and a two-dimensional matrix of (C×T_{L}); at step 405, perform normalization processing on the two-dimensional matrix of (T_{S}×T_{L}) obtained by calculation in step 404, so that the sum of the elements of each column in the two-dimensional matrix of (TS×TL) is 1; at step 406, calculate the product of the two-dimensional matrix of (T_{S}×T_{L}) and the two-dimensional matrix of (T_{L} ×C) output in step 405 to obtain a new two-dimensional matrix of (T_{S}×C); at step 407, perform linear transformation on the new two-dimensional matrix of (T_{S}×C) to obtain a reference proposal feature; at step 408, perform overfitting, i. e., to perform dropout to solve the overfitting problem; and at step 409, calculate the sum of the reference proposal feature and the short-term proposal feature to obtain an intermediate proposal feature S′. The reference proposal feature has the same size as a matrix corresponding to the short-term proposal feature. Unlike the non-local attention operation performed by a standard non-local block, in the embodiments of the present application, a self-attention mechanism is replaced with mutual attention between S and L. The normalization processing may be implemented by first multiplying each element in the two-dimensional matrix of (T_{S}×T_{L}) obtained by calculation in step 404 by ²\sqrt{1/C} to obtain a new two-dimensional matrix of (T_{S}×T_{L}), and then performing a Softmax operation. The linear operations performed by 401 to 403 and 407 are the same or different. Optionally, 401 to 403 and 407 all correspond to the same linear function. Splicing the short-term proposal feature and the intermediate proposal feature in channel dimension to obtain a target proposal feature may be the following: at first, reducing the number of channels of the intermediate proposal feature from C to D, and then, splicing the short-term proposal feature and the processed intermediate proposal feature (corresponding to the number of D channels) in channel dimension. For example, the short-term proposal feature is a two-dimensional matrix of (T_{S}×401), and the intermediate proposal feature is a two-dimensional matrix of (T_{S}×401). The intermediate proposal feature is converted into a two-dimensional matrix of (T_{S}×128) by using linear transformation, and the short-term proposal feature and the transformed intermediate proposal feature are spliced in channel dimension to obtain a two-dimensional matrix of (T_{S}×529); where D is an integer less than C and greater than 0, 401 corresponds to C, and 128 corresponds to D.

In this way, interactive information between the long-term proposal feature and the short-term proposal feature as well as other multi-granularity clues can be integrated to generate rich proposal features, thereby improving the accuracy of proposal quality evaluation.

To more clearly describe the temporal proposal generation method and the proposal quality evaluation method provided in the present application. The following further makes description with reference to the structure of an image processing apparatus.

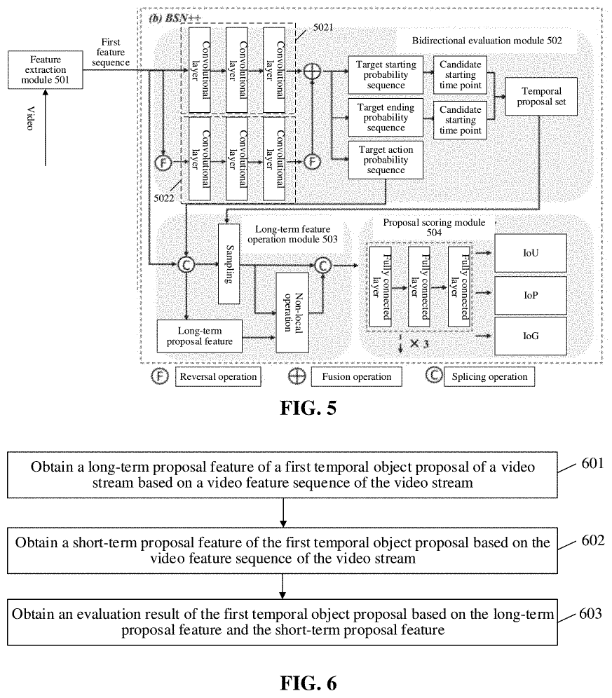

FIG. 5 is a schematic structural diagram of an image processing apparatus provided in embodiments of the present application. As shown in FIG. 5, the image processing apparatus may include four parts, the first part is a feature extraction module 501, the second part is a bidirectional evaluation module 502, the third part is a long-term feature operation module 503, and the fourth part is a proposal scoring module 504. The feature extraction module 501 is configured to perform feature extraction on an untrimmed video to obtain an original two-stream feature sequence (i. e., a first feature sequence).

The feature extraction module 501 may perform feature extraction on an untrimmed video by using a two-stream network, or may perform feature extraction on the untrimmed video by using other networks. No limitation is made in the present application. Feature extraction is performed on an untrimmed video to obtain a feature sequence is a common technical means in the art, and details are not described herein again.

The bidirectional evaluation module 502 may include a processing unit and a generation unit. In FIG. 5, 5021 represents a first proposal generation network and 5022 represents a second proposal generation network. The first proposal generation network is configured to process an input first feature sequence to obtain a first starting probability sequence, a first ending probability sequence, and a first action probability sequence, and the second proposal generation network is configured to process an input second feature sequence to obtain a second starting probability sequence, a second ending probability sequence, and a second action probability sequence. As shown in FIG. 5, the first proposal generation network and the second proposal generation network each include three temporal convolutional layers, and configured parameters are the same. The processing unit is configured to implement the functions of the first proposal generation network and the second proposal generation network. F in FIG. 5 represents a reversal operation. One F represents reversing the order of features in the first feature sequence to obtain the second feature sequence; and the other F represents reversing the order of probabilities in the second starting probability sequence to obtain a reference starting probability sequence, reversing the order of probabilities in the second ending probability sequence to obtaining a reference ending probability sequence, and reversing the order of probabilities in the second action probability sequence to obtain a reference action probability sequence. The processing unit is configured to implement the reversal operation in FIG. 5. “+” In FIG. 5 represents a fusion operation. The processing unit is further configured to fuse the first starting probability sequence and the reference starting probability sequence to obtain a target starting probability sequence, fuse the first ending probability sequence and the reference ending probability sequence to obtain a target ending probability sequence, and fuse the first action probability sequence and the reference action probability sequence to obtain a target action probability sequence. The processing unit is further configured to determine a first segment set and a second segment set. The generation unit is configured to generate a temporal object proposal set (i. e., a candidate proposal set in FIG. 5) according to the first segment set and the second segment set. During specific implementation, the generation unit can implement the method mentioned in step 104 and a method that can equivalently replace said method; and the processing unit is specifically configured to implement the method mentioned in step 102 and step 103 and a method that can equivalently replace said method.

The long-term feature operation module 503 corresponds to the feature determination unit in the embodiments of the present application. “C” in FIG. 5 represents a splicing operation. One “C” represents splicing the first feature sequence and the target action probability sequence in channel dimension to obtain a video feature sequence; and the other “C” represents splicing an original short-term proposal feature and an adjusted short-term proposal feature (corresponding to an intermediate proposal feature) in channel dimension to obtain a target proposal feature. The long-term feature operation module 503 is configured to perform sampling on features in the video feature sequence to obtain a long-term proposal feature; further configured to determine a sub-feature sequence corresponding to each temporal object proposal in the video object sequence, and perform sampling on the sub-feature sequence corresponding to the each temporal object proposal in the video object sequence to obtain a short-term proposal feature of the each temporal object proposal (corresponding to the original short-term proposal feature); further configured to take the long-term proposal feature and the short-term proposal feature of the each temporal object proposal as input to perform a non-local attention operation to obtain an intermediate proposal feature corresponding to the each temporal object proposal; and further configured to splice the short-term proposal feature of the each temporal object proposal and the intermediate proposal feature corresponding to the each temporal object proposal on channels to obtain a proposal feature set.

The proposal scoring module 504 corresponds to the evaluation unit in the present application. 5041 in FIG. 5 is a proposal evaluation network. The proposal evaluation network may include three sub-networks, i. e., a first proposal evaluation sub-network, a second proposal evaluation sub-network, and a third proposal evaluation sub-network. The first proposal evaluation sub-network is configured to process the input proposal feature set to output a first indicator (i. e., IoU) of the each temporal object proposal in the temporal object proposal set, the second proposal evaluation sub-network is configured to process the input proposal feature set to output a second indicator (i. e., IoP) of the each temporal object proposal in the temporal object proposal set, and the third proposal evaluation sub-network is configured to process the input proposal feature set to output a third indicator of each temporal object proposal in the temporal object proposal set (i. e., IoG). The network structures of the three proposal evaluation sub-networks may be the same or different, and parameters corresponding to the proposal evaluation sub-networks are different. The proposal scoring module 504 is used to implement the function of the proposal evaluation network; and further configured to determine a confidence score of the each temporal object proposal according to at least two quality indicators of the each temporal object proposal.

It should be noted that it should be understood that the division of modules of the image processing apparatus shown in FIG. 5 is only a division of logical functions, and the modules may be integrated in whole or part into a physical entity or may be physically separated in actual implementation. Moreover, these modules may all be implemented in the form of software invoked through processing elements; the modules can also be implemented in the form of hardware; and some modules may further be implemented through software invoked through processing elements, and some modules can be implemented in hardware.

As can be seen from FIG. 5, the image processing apparatus mainly completes two sub-tasks: temporal action proposal generation and proposal quality evaluation. The bidirectional evaluation module 502 is configured to complete the temporal action proposal generation, and the long-term feature operation module 503 and the proposal scoring module 504 are configured to complete the proposal quality evaluation. In practical application, before performing these two sub-tasks, the image processing apparatus needs to obtain or train to obtain the first proposal generation network 5021, the second proposal generation network 5022, and the proposal evaluation network 5041. In a usually used bottom-up proposal generation method, the temporal proposal generation and the proposal quality evaluation are often independently trained and there is a lack of overall optimization. In the embodiments of the present application, the temporal action proposal generation and the proposal quality evaluation are integrated into a unified framework for joint training. The following describes a method for training the first proposal generation network, the second proposal generation network, and the proposal evaluation network.

Optionally, a training process is as follows: inputting a first training sample to the first proposal generation network for processing to obtain a first sample starting probability sequence, a first sample action probability sequence, and a first sample ending probability sequence, and inputting a second training sample to the second proposal generation network for processing to obtain a second sample starting probability sequence, a second sample action probability sequence, and a second sample ending probability sequence; fusing the first sample starting probability sequence and the second sample starting probability sequence to obtain a target sample starting probability sequence; fusing the first sample ending probability sequence and the second sample ending probability sequence to obtain a target sample ending probability sequence; fusing the first sample action probability sequence and the second sample action probability sequence to obtain a target sample action probability sequence; generating a sample temporal object proposal set based on the target sample starting probability sequence and the target sample ending probability sequence; obtaining a sample proposal feature set based on the sample temporal object proposal set, the target sample action probability sequence, and the first training sample; inputting the sample proposal feature set to the proposal evaluation network for processing to obtain at least one quality indicator of each sample proposal feature in the sample proposal feature set; determining a confidence score of the each sample proposal feature according to at least one quality indicator of the each sample proposal feature; and updating the first proposal generation network, the second proposal generation network, and the proposal evaluation network according to a weighted sum of a first loss corresponding to the first proposal generation network and the second proposal generation network and a second loss corresponding to the proposal evaluation network.

The operation of obtaining the sample proposal feature set based on the sample temporal object proposal set, the target sample action probability sequence, and the first training sample is similar to the operation of obtaining the proposal feature set by the long-term feature operation module 503 in FIG. 5. Details are not described herein again. It may be understood that the process of obtaining the sample proposal feature set in the training process is the same as the process of generating the temporal object proposal set in an application process; and the process of determining the confidence score of each sample temporal proposal in the training process is the same as the process of determining the confidence score of the each temporal proposal in the application process. Upon comparison, the main difference between the training process and the application process is updating the first proposal generation network, the second proposal generation network, and the proposal evaluation network according to the weighted sum of the first loss corresponding to the first proposal generation network and the second proposal generation network and the second loss corresponding to the proposal evaluation network.

The first loss corresponding to the first proposal generation network and the second proposal generation network is a loss corresponding to the bidirectional evaluation module 502. The loss function for calculating the first loss corresponding to the first proposal generation network and the second proposal generation network is as follows:

L_{BEM}=λₛ·L_{BEM}^{s}+λₑ·L_{BEM}^{e}+λ_{α}·L_{BEM}^{α} (4);

where λₛ, λₑ and λₐ are weighting factors and may be configured according to actual situations, for example, they are all be set to 1; L_{BEM}^{s}, L_{BEM}^{e} and L_{BEM}^{a} sequentially represent losses of the target starting probability sequence, the target ending probability sequence; and the target action probability sequence, and L_{BEM}^{s}, L_{BEM}^{e} and L_{BEM}^{a} are all cross-entropy loss functions, and the specific form is:

$${L}_{BEM}^{′} = \frac{1}{{T}_{w}} {\sum }_{t = 1}^{{T}_{w}} ( {α}^{+} \cdot {b}_{t} \cdot log ( {p}_{t} ) + {α}^{-} \cdot ( 1 - {b}_{t} ) \cdot log ( 1 - {p}_{t} ) ) ; \qquad ( 5 )$$

where bₜ=sign(gₜ−0.5) is used for binarizing a corresponding IoP truth value gₜ, matched at each moment. α⁺ and α⁻ are used for balancing a proportion of positive and negative samples during training. Moreover,

$${α}^{+} = \frac{{T}_{w}}{{T}^{-}} and {α}^{-} = \frac{{T}_{w}}{{T}^{+}} ,$$

where T⁺=Σgₜ, T⁻=T_{w}−T⁺. Functions corresponding to L_{BEM}^{s}, L_{BEM}^{e} and L_{BEM}^{α} are similar. For L_{BEM}^{s}, in (5), pₜ is a starting probability at moment t in the target starting probability sequence, gₜ is the corresponding IoP truth value matched at moment t; for L_{BEM}^{e}, in (5), pₜ is an ending probability at moment t in the target ending probability sequence, and gₜ is the corresponding IoP truth value matched at moment t; and for L_{BEM}^{e}, in (5), pₜ is an action probability at moment t in the target action probability sequence, and gₜ is the corresponding IoP truth value matched at moment t.

The second loss corresponding to the proposal evaluation network is a loss corresponding to the proposal scoring module 504. The loss function for calculating the second loss corresponding to the proposal evaluation network is as follows:

L_{PSM}=λ_{IoU}·L_{PSM}^{IoU}+λ_{IoP}·L_{PSM}^{IoP}+λ_{IoG}·L_{PSM}^{IoG} (6);

where λ_{IoU}, λ_{IoP} and λ_{IoG} are weighting factors and may be configured according to actual situations. L_{PSM}^{IoU}, L_{PSM}^{IoP}, and L_{PSM}^{IoG} sequentially represent the losses of the first indicator (IoU), the second indicator (IoP), and the third indicator (IoG).

The weighted sum of the first loss corresponding to the first proposal generation network and the second proposal generation network and the second loss corresponding to the proposal evaluation network is a loss of the entire network framework. The loss function of the entire network framework is:

L_{BSN++}=L_{BEM}+β·L_{PSM} (7);

where β is a weighting factor and may be set to 10, L_{BEM} represents the first loss corresponding to the first proposal generation network and the second proposal generation network, and L_{PSM} represents the second loss corresponding to the proposal evaluation network. The image processing apparatus may update parameters of the first proposal generation network, the second proposal generation network, and the proposal evaluation network by using an algorithm such as back propagation according to the loss calculated by (7). The condition for stopping training may be that the number of iterative updates reaches a threshold, for example, 10,000 times, or that the loss value of the entire network framework converges, i. e., the loss of the entire network framework does not decrease basically.

In the embodiments of the present application, the first proposal generation network, the second proposal generation network, and the proposal evaluation network are jointly trained as a whole, so that the quality of proposal evaluation is steadily improved while the precision of the temporal proposal set is effectively improved, thereby ensuring the reliability of subsequent proposal retrieval.

In practical application, a proposal evaluation apparatus may use at least three different methods described in the foregoing embodiments to evaluate the quality of a temporal object proposal. The following describes method flows of these three method for proposal evaluations with reference to the accompanying drawings.

FIG. 6 is a flowchart of a method for proposal evaluation provided in embodiments of the present application. The method includes the following steps.

At 601, a long-term proposal feature of a first temporal object proposal of a video stream is obtained based on a video feature sequence of the video stream.

The video feature sequence includes feature data of each of multiple segments included in the video stream, and a time period corresponding to the long-term proposal feature is longer than a time period corresponding to the first temporal object proposal.

At 602, a short-term proposal feature of the first temporal object proposal is obtained based on the video feature sequence of the video stream.

A time period corresponding to the short-term proposal feature is the same as the time period corresponding to the first temporal object proposal.

At 603, an evaluation result of the first temporal object proposal is obtained based on the long-term proposal feature and the short-term proposal feature.

In the embodiments of the present application, interactive information between the long-term proposal feature and the short-term proposal feature as well as other multi-granularity clues can be integrated to generate rich proposal features, thereby improving the accuracy of proposal quality evaluation.

It should be understood that, for the specific implementation of the method for proposal evaluation provided in the embodiments of the present disclosure, reference may be made to the specific description above. For the purpose of brevity, details are not described herein again.

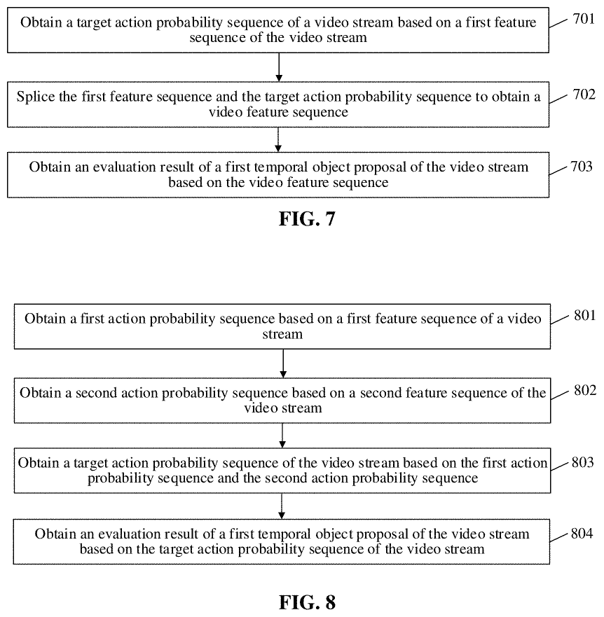

FIG. 7 is a flowchart of another method for proposal evaluation provided in embodiments of the present application. The method includes the following steps.

At 701, a target action probability sequence of a video stream is obtained based on a first feature sequence of the video stream.

The first feature sequence includes feature data of each of multiple segments of the video stream.

At 702, the first feature sequence and the target action probability sequence are spliced to obtain a video feature sequence.

At 703, an evaluation result of a first temporal object proposal of the video stream is obtained based on the video feature sequence.

In the embodiments of the present application, the feature sequence and the target action probability sequence are spliced in channel dimension to obtain a video feature sequence including more feature information, so that the proposal features obtained by sampling include rich information.

It should be understood that, for the specific implementation of the method for proposal evaluation provided in the embodiments of the present disclosure, reference may be made to the specific description above. For the purpose of brevity, details are not described herein again.

FIG. 8 is a flowchart of another method for proposal evaluation provided in embodiments of the present application. The method includes the following steps.

At 801, a first action probability sequence is obtained based on a first feature sequence of a video stream.

The first feature sequence includes feature data of each of multiple segments of the video stream.

At 802, a second action probability sequence is obtained based on a second feature sequence of the video stream.

The feature data included in the second feature sequence is the same as that included in the first feature sequence and is arranged in a reverse order.

At 803, a target action probability sequence of the video stream is obtained based on the first action probability sequence and the second action probability sequence.

At 804, an evaluation result of a first temporal object proposal of the video stream is obtained based on the target action probability sequence of the video stream.

In the embodiments of the present application, a more accurate target action probability sequence can be obtained based on the first action probability sequence and the second action probability sequence, so that the quality of the temporal object proposal can be evaluated more accurately by using the target action probability sequence.

It should be understood that, for the specific implementation of the method for proposal evaluation provided in the embodiments of the present disclosure, reference may be made to the specific description above. For the purpose of brevity, details are not described herein again.

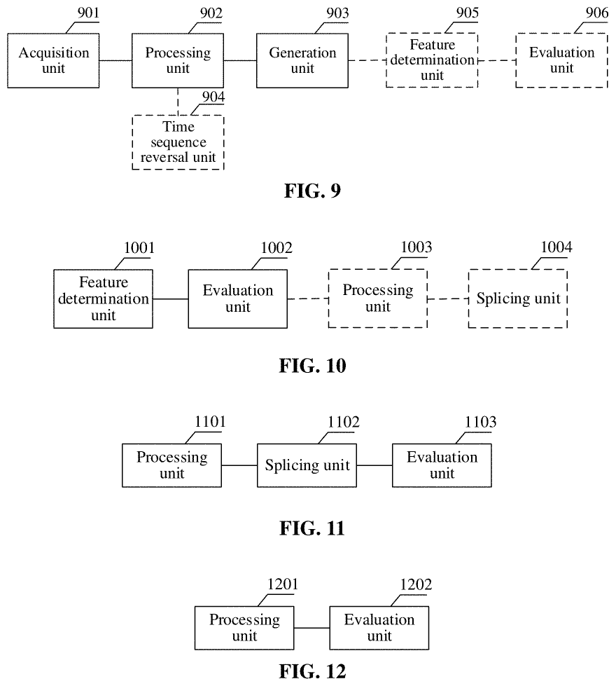

FIG. 9 is a schematic structural diagram of an image processing apparatus provided in embodiments of the present application. As shown in FIG. 9, the image processing apparatus includes:

an acquisition unit 901, configured to acquire a first feature sequence of a video stream, where the first feature sequence includes feature data of each of multiple segments of the video stream;

a processing unit 902, configured to obtain a first object boundary probability sequence based on the first feature sequence, where the first object boundary probability sequence includes probabilities that the multiple segments belong to an object boundary;

the processing unit 902, further configured to obtain a second object boundary probability sequence based on a second feature sequence of the video stream, where the feature data included in the second feature sequence is the same as that included in the first feature sequence and is arranged in a reverse order; and

a generation unit 903, configured to generate a temporal object proposal set based on the first object boundary probability sequence and the second object boundary probability sequence.

In the embodiments of the present application, a temporal object proposal set is generated based on the fused probability sequences, and thus, a probability sequence can be determined more accurately, so that the boundary of the generated temporal proposal is more precise.

In an optional implementation, a time sequence reversal unit 904 is configured to perform time sequence reversal processing on the first feature sequence to obtain the second feature sequence.

In an optional implementation, the generation unit 903 is specifically configured to perform fusing processing on the first object boundary probability sequence and the second object boundary probability sequence to obtain a target boundary probability sequence; and generate the temporal object proposal set based on the target boundary probability sequence.

In this implementation, the image processing apparatus performs fusion processing on the two object boundary probability sequences to obtain a more accurate object boundary probability sequence, and then obtain a more accurate temporal object proposal set.

In an optional implementation, the generation unit 903 is specifically configured to perform time sequence reversal processing on the second object boundary probability sequence to obtain a third object boundary probability sequence; and fuse the first object boundary probability sequence and the third object boundary probability sequence to obtain the target boundary probability sequence.

In an optional implementation, each of the first object boundary probability sequence and the second object boundary probability sequence includes a starting probability sequence and an ending probability sequence.

The generation unit 903 is specifically configured to perform fusing on the starting probability sequences in the first object boundary probability sequence and the second object boundary probability sequence to obtain a target starting probability sequence; and/or

the generation unit 903 is specifically configured to perform fusing processing on the ending probability sequences in the first object boundary probability sequence and the second object boundary probability sequence to obtain a target ending probability sequence, where the target boundary probability sequence includes at least one of the target starting probability sequence and the target ending probability sequence.

In an optional implementation, the generation unit 903 is specifically configured to generate the temporal object proposal set based on the target starting probability sequence and the target ending probability sequence included in the target boundary probability sequence;

or the generation unit 903 is specifically configured to generate the temporal object proposal set based on the target starting probability sequence included in the target boundary probability sequence and the ending probability sequence included in the first object boundary probability sequence;

or the generation unit 903 is specifically configured to generate the temporal object proposal set based on the target starting probability sequence included in the target boundary probability sequence and the ending probability sequence included in the second object boundary probability sequence;

or the generation unit 903 is specifically configured to generate the temporal object proposal set based on the starting probability sequence included in the first object boundary probability sequence and the target ending probability sequence included in the target boundary probability sequence;

or the generation unit 903 is specifically configured to generate the temporal object proposal set based on the starting probability sequence included in the second object boundary probability sequence and the target ending probability sequence included in the target boundary probability sequence.

In an optional implementation, the generation unit 903 is specifically configured to obtain a first segment set based on target starting probabilities of the multiple segments included in the target starting probability sequence, and obtain a second segment set based on target ending probabilities of the multiple segments included in the target ending probability sequence, where the first segment set includes at least one segment with a target starting probability exceeding a first threshold and/or at least one segment with a target starting probability being higher than that of at least two adjacent segments, and the second segment set includes at least one segment with a target ending probability exceeding a second threshold and/or at least one segment with a target ending probability being higher than that of at least two adjacent segments; and generate the temporal object proposal set based on the first segment set and the second segment.

In an optional implementation, the apparatus further includes:

a feature determination unit 905, configured to obtain a long-term proposal feature of a first temporal object proposal based on a video feature sequence of the video stream, where a time period corresponding to the long-term proposal feature is longer than a time period corresponding to the first temporal object proposal, and the first temporal object proposal is included in the temporal object proposal set; and obtain a short-term proposal feature of the first temporal object proposal based on the video feature sequence of the video stream, where a time period corresponding to the short-term proposal feature is the same as the time period corresponding to the first temporal object proposal; and

an evaluation unit 906, configured to obtain an evaluation result of the first temporal object proposal based on the long-term proposal feature and the short-term proposal feature.

In an optional implementation, the feature determination unit 905 is further configured to obtain a target action probability sequence based on at least one of the first feature sequence and the second feature sequence; and splice the first feature sequence and the target action probability sequence to obtain the video feature sequence.

In an optional implementation, the feature determination unit 905 is specifically configured to perform sampling on the video feature sequence based on the time period corresponding to the first temporal object proposal to obtain the short-term proposal feature.

In an optional implementation, the feature determination unit 905 is specifically configured to obtain a target proposal feature of the first temporal object proposal based on the long-term proposal feature and the short-term proposal feature; and

the evaluation unit 906 is specifically configured to obtain the evaluation result of the first temporal object proposal based on the target proposal feature of the first temporal object proposal.

In an optional implementation, the feature determination unit 905 is specifically configured to perform a non-local attention operation on the long-term proposal feature and the short-term proposal feature to obtain an intermediate proposal feature; and splice the short-term proposal feature and the intermediate proposal feature to obtain the target proposal feature.

In an optional implementation, the feature determination unit 905 is specifically configured to obtain the long-term proposal feature based on feature data corresponding to a reference time interval in the video feature sequence, where the reference time interval is from the starting time of the first temporal object in the temporal object proposal set to the ending time of the last temporal object in the temporal object proposal set.

In an optional implementation, the evaluation unit 905 is specifically configured to: input the target proposal feature to a proposal evaluation network for processing to obtain at least two quality indicators of the first temporal object proposal, where a first indicator of the at least two quality indicators is used for representing a proportion of an intersection of the first temporal object proposal and a truth value in the length of the first temporal object proposal, and a second indicator of the at least two quality indicators is used for representing a proportion of the intersection of the first temporal object proposal and the truth value in the length of the truth value; and obtain the evaluation result based on the at least two quality indicators.

In an optional implementation, a method for image processing implemented by the apparatus is applied to a temporal proposal generation network, and the temporal proposal generation network includes a proposal generation network and a proposal evaluation network; where the processing unit is configured to implement the function of the proposal generation network, and the evaluation unit is configured to implement the function of the proposal evaluation network;

a process for training the proposal generation network includes:

inputting a training sample to the temporal proposal generation network for processing to obtain a sample temporal proposal set output by the proposal generation network and evaluation results of sample temporal proposals included in the sample temporal proposal set output by the proposal evaluation network;

obtaining a network loss based on differences respectively between the sample temporal proposal set of the training sample and the evaluation results of the sample temporal proposals included in the sample temporal proposal set and labeling information of the training sample; and

adjusting network parameters of the temporal proposal generation network based on the network loss.

FIG. 10 is a schematic structural diagram of a proposal evaluation apparatus provided in embodiments of the present application. As shown in FIG. 10, the proposal evaluation apparatus includes:

a feature determination unit 1001, configured to obtain a long-term proposal feature of a first temporal object proposal based on a video feature sequence of a video stream, where the video feature sequence includes feature data of each of multiple segments included in the video stream and an action probability sequence obtained based on the video stream, or the video feature sequence is an action probability sequence obtained based on the video stream, a time period corresponding to the long-term proposal feature is longer than a time period corresponding to the first temporal object proposal, and the first temporal object proposal is included in a temporal object proposal set obtained based on the video stream;

the feature determination unit 1001, further configured to obtain a short-term proposal feature of the first temporal object proposal based on the video feature sequence of the video stream, where a time period corresponding to the short-term proposal feature is the same as the time period corresponding to the first temporal object proposal; and

an evaluation unit 1002, configured to obtain an evaluation result of the first temporal proposal based on the long-term proposal feature and the short-term proposal feature.

In the embodiments of the present application, interactive information between the long-term proposal feature and the short-term proposal feature as well as other multi-granularity clues can be integrated to generate rich proposal features, thereby improving the accuracy of proposal quality evaluation.

In an optional implementation, the apparatus further includes:

a processing unit 1003, configured to obtain a target action probability sequence based on at least one of a first feature sequence and a second feature sequence, where the first feature sequence and the second feature sequence each include the feature data of each of the multiple segments of the video stream, and the feature data included in the second feature sequence is the same as that included in the first feature sequence and is arranged in a reverse order; and

a splicing unit 1004, configured to splice the first feature sequence and the target action probability sequence to obtain the video feature sequence.

In an optional implementation, the feature determination unit 1001 is specifically configured to perform sampling on the video feature sequence based on the time period corresponding to the first temporal object proposal to obtain the short-term proposal feature.

In an optional implementation, the feature determination unit 1001 is specifically configured to obtain a target proposal feature of the first temporal object proposal based on the long-term proposal feature and the short-term proposal feature; and

the evaluation unit 1002 is specifically configured to obtain the evaluation result of the first temporal object proposal based on the target proposal feature of the first temporal object proposal.

In an optional implementation, the feature determination unit 1001 is specifically configured to perform a non-local attention operation on the long-term proposal feature and the short-term proposal feature to obtain an intermediate proposal feature; and splice the short-term proposal feature and the intermediate proposal feature to obtain the target proposal feature.

In an optional implementation, the feature determination unit 1001 is specifically configured to obtain the long-term proposal feature based on feature data corresponding to a reference time interval in the video feature sequence, where the reference time interval is from the starting time of the first temporal object in the temporal object proposal set to the ending time of the last temporal object in the temporal object proposal set.

In an optional implementation, the evaluation unit 1002 is specifically configured to: input the target proposal feature to a proposal evaluation network for processing to obtain at least two quality indicators of the first temporal object proposal, where a first indicator of the at least two quality indicators is used for representing a proportion of an intersection of the first temporal object proposal and a truth value in the length of the first temporal object proposal, and a second indicator of the at least two quality indicators is used for representing a proportion of the intersection of the first temporal object proposal and the truth value in the length of the truth value; and obtain the evaluation result based on the at least two quality indicators.

FIG. 11 is a schematic structural diagram of another proposal evaluation apparatus provided in embodiments of the present application. As shown in FIG. 11, the proposal evaluation apparatus includes:

a processing unit 1101, configured to obtain a target action probability sequence of a video stream based on a first feature sequence of the video stream, where the first feature sequence includes feature data of each of multiple segments of the video stream;

a splicing unit 1102, configured to splice the first feature sequence and the target action probability sequence to obtain a video feature sequence; and

an evaluation unit 1103, configured to obtain an evaluation result of the first temporal object proposal of the video stream based on the video feature sequence.

Optionally, the evaluation unit 1103 is specifically configured to obtain a target proposal feature of the first temporal object proposal based on the video feature sequence, where a time period corresponding to the target proposal feature is the same as a time period corresponding to the first temporal object proposal, and the first temporal object proposal is included in a temporal object proposal set obtained based on the video stream; and obtaining an evaluation result of the first temporal object proposal based on the target proposal feature.

In the embodiments of the present application, the feature sequence and the target action probability sequence are spliced in channel dimension to obtain a video feature sequence including more feature information, so that the proposal features obtained by sampling include rich information.

In an optional implementation, the processing unit 1101 is specifically configured to obtain a first action probability sequence based on the first feature sequence; obtain a second action probability sequence based on the second feature sequence; and fuse the first action probability sequence and the second action probability sequence to obtain the target action probability sequence. Optionally, the target action probability sequence may be the first action probability sequence or the second action probability sequence.

FIG. 12 is a schematic structural diagram of still another proposal evaluation apparatus provided in embodiments of the present application. As shown in FIG. 12, the proposal evaluation apparatus includes:

a processing unit 1201, configured to obtain a target action probability sequence based on a first feature sequence of a video stream, where the first feature sequence includes feature data of each of multiple segments of the video stream;

obtain a second action probability sequence based on a second feature sequence of the video stream, where the feature data included in the second feature sequence is the same as that included in the first feature sequence and is arranged in a reverse order; and

obtain a target action probability sequence of the video stream based on the first action probability sequence and the second action probability sequence; and

an evaluation unit 1202, configured to obtain an evaluation result of a first temporal object proposal of the video stream based on the target action probability sequence of the video stream.

Optionally, the processing unit 1201 is specifically configured to perform fusing processing on the first action probability sequence and the second action probability sequence to obtain the target action probability sequence.

In the embodiments of the present application, a more accurate target action probability sequence can be obtained based on the first action probability sequence and the second action probability sequence, so that the quality of the temporal object proposal can be evaluated more accurately by using the target action probability sequence.

It should be understood that the division of units of the image processing apparatus and the proposal evaluation apparatus above is only a division of logical functions, and the units may be integrated in whole or part into a physical entity or may be physically separated in actual implementation. For example, the units above may be separate processing elements or may be integrated into the same chip. In addition, the units may also be stored in a storage element of a controller in the form of a program code, and the units are invoked by a certain processing unit of a processor to implement the functions of the units above. In addition, the units may be integrated together or may be implemented independently. The processing element herein may be an integrated circuit chip and has a signal processing capability. During implementation, the steps of the foregoing method or the units above may be completed through an integrated logic circuit of hardware in the processor unit or instructions in the form of software. The processing element may be a general-purpose processor, such as a central processing unit (abbreviated as CPU), or may be one or more integrated circuits configured to implement the method above, such as one or more application-specific integrated circuits (abbreviated as ASICs), or one or more microprocessors (digital signal processors, abbreviated as DSPs), or one or more field-programmable gate arrays (abbreviated as FPGAs).

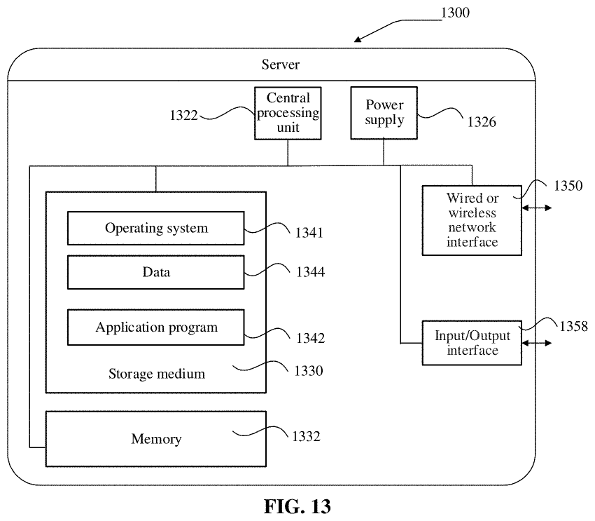

FIG. 13 is a schematic structural diagram of a server provided in embodiments of the present invention. The server 1300 may have a relatively large difference due to different configurations or performances, and may include one or more central processing units (CPUs) 1322 (such as one or more processors) and a memory 1332, as well as one or one storage media 1330 (such as one or one mass storage devices) storing an application program 1342 or data 1344. The memory 1332 and the storage medium 1330 may be a transitory storage or persistent storage. The program stored in the storage medium 1330 may include one or more modules (not shown in the drawings), and each module may include a series of instruction operations in the server. Furthermore, the CPU 1322 may be configured to communicate with the storage medium 1330 and execute a series of instruction operations in the storage medium 1330 on the server 1300. The server 1300 may be an image processing apparatus provided in the present application.

The server 1300 may also include one or more power supplies 1326, one or more wired or wireless network interfaces 1350, one or more input/output interfaces 1358, and/or one or more operating systems 1341, such as Windows Server™, Mac OS X™, Unix™, Linux™, FreeBSD™, etc.

The steps performed by the server in the foregoing embodiments may be based on the server structure shown in FIG. 13. Specifically, the CPU 1322 can implement the functions of the units in FIGS. 9 to 12.

The embodiments of the present invention provide a computer-readable storage medium, storing a computer program, where the computer program is executed by a processor to: acquire a first feature sequence of a video stream, where the first feature sequence includes feature data of each of multiple segments of the video stream; obtain a first object boundary probability sequence based on the first feature sequence, where the first object boundary probability sequence includes probabilities that the multiple segments belong to an object boundary; obtain a second object boundary probability sequence based on a second feature sequence of the video stream, where the feature data included in the second feature sequence is the same as that included in the first feature sequence and is arranged in a reverse order; and generate a temporal object proposal set based on the first object boundary probability sequence and the second object boundary probability sequence.

The embodiments of the present invention provide another computer-readable storage medium, storing a computer program, where the computer program is executed by a processor to: obtain a long-term proposal feature of a first temporal object proposal based on a video feature sequence of a video stream, where the video feature sequence includes feature data of each of multiple segments included in the video stream and an action probability sequence obtained based on the video stream, or the video feature sequence is an action probability sequence obtained based on the video stream, a time period corresponding to the long-term proposal feature is longer than a time period corresponding to the first temporal object proposal, and the first temporal object proposal is included in a temporal object proposal set obtained based on the video stream; obtain a short-term proposal feature of the first temporal object proposal based on the video feature sequence of the video stream, where a time period corresponding to the short-term proposal feature is the same as the time period corresponding to the first temporal object proposal; and obtain an evaluation result of the first temporal object proposal based on the long-term proposal feature and the short-term proposal feature.

The embodiments of the present invention provide still another computer-readable storage medium, storing a computer program, where the computer program is executed by a processor to: obtain a target action probability sequence based on at least one of a first feature sequence and a second feature sequence, where the first feature sequence and the second feature sequence each include feature data of each of multiple segments of a video stream, and the feature data included in the second feature sequence is the same as that included in the first feature sequence and is arranged in a reverse order; splice the first feature sequence and the target action probability sequence to obtain a video feature sequence; obtain a target proposal feature of a first temporal object proposal based on the video feature sequence, where a time period corresponding to the target proposal feature is the same as a time period corresponding to the first temporal object proposal, and the first temporal object proposal is included in a temporal object proposal set obtained based on the video stream; and obtain an evaluation result of the first temporal object proposal based on the target proposal feature.

The descriptions above are only specific implementations of the present invention. However, the scope of protection of the present invention is not limited thereto. Within the technical scope disclosed by the present invention, any variation or substitution that can be easily conceived of by a person skilled in the art should all fall within the scope of protection of the present invention. Therefore, the scope of protection of the present invention should be determined by the scope of protection of the claims.

1. A method for image processing, comprising:
acquiring a first feature sequence of a video stream, wherein the first feature sequence comprises feature data of each of multiple segments in the video stream;
obtaining a first object boundary probability sequence based on the first feature sequence, wherein the first object boundary probability sequence comprises probabilities that the multiple segments belong to an object boundary;
obtaining a second object boundary probability sequence based on a second feature sequence of the video stream, wherein the second feature sequence and the first feature sequence include the same feature data, but arranged in a reverse order; and
generating a temporal object proposal set based on the first object boundary probability sequence and the second object boundary probability sequence.

2. The method according to claim 1, wherein before obtaining the second object boundary probability sequence based on the second feature sequence of the video stream, the method further comprises:
performing time sequence reversal processing on the first feature sequence to obtain the second feature sequence.

3. The method according to claim 1, wherein generating the temporal object proposal set based on the first object boundary probability sequence and the second object boundary probability sequence comprises:
performing fusion processing on the first object boundary probability sequence and the second object boundary probability sequence to obtain a target boundary probability sequence; and
generating the temporal object proposal set based on the target boundary probability sequence.

4.-7. (canceled)

8. The method according to claim 1, further comprising:
obtaining a long-term proposal feature of a first temporal object proposal based on a video feature sequence of the video stream, wherein a time period corresponding to the long-term proposal feature is longer than a time period corresponding to the first temporal object proposal, and the first temporal object proposal is comprised in the temporal object proposal set;
obtaining a short-term proposal feature of the first temporal object proposal based on the video feature sequence of the video stream, wherein a time period corresponding to the short-term proposal feature is the same as the time period corresponding to the first temporal object proposal; and
obtaining an evaluation result of the first temporal object proposal based on the long-term proposal feature and the short-term proposal feature.

9. The method according to claim 8, wherein before obtaining the long-term proposal feature of the first temporal object proposal of the video stream based on the video feature sequence of the video stream, the method further comprises:
obtaining a target action probability sequence based on at least one of the first feature sequence or the second feature sequence; and
splicing the first feature sequence and the target action probability sequence to obtain the video feature sequence.

10. The method according to claim 8, wherein obtaining the short-term proposal feature of the first temporal object proposal based on the video feature sequence of the video stream comprises:
performing sampling on the video feature sequence based on the time period corresponding to the first temporal object proposal to obtain the short-term proposal feature.

11. The method according to claim 8, wherein obtaining the evaluation result of the first temporal object proposal based on the long-term proposal feature and the short-term proposal feature comprises:
obtaining a target proposal feature of the first temporal object proposal based on the long-term proposal feature and the short-term proposal feature; and
obtaining the evaluation result of the first temporal object proposal based on the target proposal feature of the first temporal object proposal.

12. (canceled)

13. The method according to claim 8, wherein obtaining the long-term proposal feature of the first temporal object proposal based on the video feature sequence of the video stream comprises:
obtaining the long-term proposal feature based on feature data corresponding to a reference time interval in the video feature sequence, wherein the reference time interval ranges from a starting time of a first temporal object in the temporal object proposal set to an ending time of a last temporal object in the temporal object proposal set.

14. The method according to claim 8, further comprising:
inputting a target proposal feature to a proposal evaluation network for processing to obtain at least two quality indicators of the first temporal object proposal, wherein a first indicator of the at least two quality indicators is used for representing a proportion of an intersection of the first temporal object proposal and a truth value in a length of the first temporal object proposal, and a second indicator of the at least two quality indicators is used for representing a proportion of the intersection of the first temporal object proposal and the truth value in a length of the truth value; and
obtaining the evaluation result based on the at least two quality indicators.

15. The method according to claim 1, wherein the method for image processing is applied to a temporal proposal generation network, and the temporal proposal generation network comprises a proposal generation network and a proposal evaluation network;
wherein training of the proposal generation network comprises:
inputting a training sample to the temporal proposal generation network for processing to obtain a sample temporal proposal set output by the proposal generation network and evaluation results of sample temporal proposals comprised in the sample temporal proposal set output by the proposal evaluation network;
obtaining a network loss based on differences respectively between the sample temporal proposal set of the training sample and the evaluation results of the sample temporal proposals comprised in the sample temporal proposal set and labeling information of the training sample; and
adjusting network parameters of the temporal proposal generation network based on the network loss.

16.-22. (canceled)

23. A method for proposal evaluation, comprising:
obtaining a target action probability sequence of a video stream based on a first feature sequence of the video stream, wherein the first feature sequence comprises feature data of each of multiple segments in the video stream;
splicing the first feature sequence and the target action probability sequence to obtain a video feature sequence; and
obtaining an evaluation result of a first temporal object proposal of the video stream based on the video feature sequence.

24. The method according to claim 23, obtaining the target action probability sequence of the video stream based on the first feature sequence of the video stream comprises:
obtaining a first action probability sequence based on the first feature sequence;
obtaining a second action probability sequence based on a second feature sequence of the video stream, wherein the second feature sequence and the first feature sequence comprise same feature data arranged in a reverse order; and
performing fusing processing on the first action probability sequence and the second action probability sequence to obtain the target action probability sequence.

25. (canceled)

26. The method according to claim 23, wherein obtaining the evaluation result of the first temporal object proposal of the video stream based on the video feature sequence comprises:
performing sampling on the video feature sequence based on a time period corresponding to the first temporal object proposal to obtain a target proposal feature; and
obtaining the evaluation result of the first temporal object proposal based on the target proposal feature.

27. (canceled)

28. The method according to claim 24, wherein before obtaining the evaluation result of the first temporal object proposal of the video stream based on the video feature sequence, the method further comprises:
obtaining a first object boundary probability sequence based on the first feature sequence, wherein the first object boundary probability sequence comprises probabilities that the multiple segments belong to an object boundary;
obtaining a second object boundary probability sequence based on the second feature sequence of the video stream; and
generating the first temporal object proposal based on the first object boundary probability sequence and the second object boundary probability sequence.

29.-30. (canceled)

31. A method for proposal evaluation, comprising:
obtaining a first action probability sequence based on a first feature sequence of a video stream, wherein the first feature sequence comprises feature data of each of multiple segments in the video stream;
obtaining a second action probability sequence based on a second feature sequence of the video stream, wherein the second feature sequence and the first feature sequence comprise same feature data arranged in a reverse order;
obtain a target action probability sequence of the video stream based on the first action probability sequence and the second action probability sequence; and
obtaining an evaluation result of a first temporal object proposal of the video stream based on the target action probability sequence of the video stream.

32. The method according to claim 31, wherein obtaining the target action probability sequence of the video stream based on the first action probability sequence and the second action probability sequence comprises:
performing fusing processing on the first action probability sequence and the second action probability sequence to obtain the target action probability sequence.

33. (canceled)

34. The method according to claim 31, wherein obtaining the evaluation result of the first temporal object proposal of the video stream based on the target action probability sequence of the video stream comprises:
obtaining a long-term proposal feature of the first temporal object proposal based on the target action probability sequence, wherein a time period corresponding to the long-term proposal feature is longer than a time period corresponding to the first temporal object proposal;
obtaining a short-term proposal feature of the first temporal object proposal based on the target action probability sequence, wherein a time period corresponding to the short-term proposal feature is the same as the time period corresponding to the first temporal object proposal; and
obtaining an evaluation result of the first temporal object proposal based on the long-term proposal feature and the short-term proposal feature.

35.-36. (canceled)

37. The method according to claim 34, wherein obtaining the evaluation result of the first temporal object proposal based on the long-term proposal feature and the short-term proposal feature comprises:
obtaining a target proposal feature of the first temporal object proposal based on the long-term proposal feature and the short-term proposal feature; and
obtaining the evaluation result of the first temporal object proposal based on the target proposal feature of the first temporal object proposal.

38. (canceled)

39. An image processing apparatus, comprising:
a processor; and
a memory configured to store instructions that, when being executed by the processor, cause the processor to implement the method according to claim 1.

40.-78. (canceled)

79. A non-transitory computer-readable storage medium, having stored therein a computer program, wherein the computer program comprises program instructions that, when being executed by a processor, cause the processor to implement the method according to claim 1.

80. (canceled)
